(19) United States
(12) Patent Application Publication
(10) Pub. No.: US 2023/0392011 A1
(43) Pub. Date: Dec. 7, 2023

(54) LIQUID SILICONE RESINS

(71) Applicant: DOW SILICONES CORPORATION, Midland, MI (US)

(72) Inventors: Sudhakar Balijepalli, Midland, MI (US); Eun Sil Jang, Midland, MI (US)

(21) Appl. No.: 18/034,009

(22) PCT Filed: Oct. 29, 2021
(86) PCT No.: PCT/US2021/057200

§ 371 Date: Apr. 26, 2023

Related U.S. Application Data
(60) Provisional application No. 63/107,643, filed on Oct. 30, 2020.

(51) Int. Cl. C08L 83/04; C08J 3/00

(52) U.S. Cl. CPC C08L 83/04; C08J 3/005; C08G 77/70

(57) ABSTRACT

A liquid silicone resin composition is provided. The liquid silicone resin composition comprises (A) a polysiloxane, (B) a polyether alcohol compound, and optionally (C) an aminosilicon compound. The polysiloxane (A) comprises an MQ resin, which is dispersed in and optionally functionalized with the polyether alcohol compound (B), and which may also optionally have amino functionality. The liquid silicone resin composition comprises a tunable viscosity, which may range at 25° C. from 100 to 800,000 cps. A method of preparing the liquid silicone resin is also provided. The method comprises combining together a solid silicone resin and the polyether alcohol compound (B) to give a mixture comprising the polysiloxane (A) and the polyether alcohol compound (B), and liquefying the mixture, thereby preparing the liquid silicone resin composition. The method may optionally include the aminosilicon compound (C).

### CROSS REFERENCE TO RELATED APPLICATIONS

This application claims priority to and all advantages of U.S. Provisional Patent Application No. 63/107,643 filed on 30 Oct. 2020, the content of which is incorporated herein by reference

### FIELD OF THE INVENTION

The present disclosure relates generally to silicone compositions and, more specifically, to a liquid silicone resin composition and methods of preparing the same.

### DESCRIPTION OF THE RELATED ART

Silicones are polymeric materials used in numerous commercial applications, primarily due to significant advantages they possess over their carbon-based analogues. More particularly referred to as polymerized siloxanes or polysiloxanes, silicones include an inorganic silicon-oxygen backbone chain (---—Si—O—Si—O—Si—O—---) having organic side groups attached to the silicon atoms. Organic side groups may be used to link two or more of these backbones together. By varying the —Si—O— chain lengths, side groups, and cross-linking, silicones can be synthesized with a wide variety of properties and compositions, with silicone networks varying in consistency from liquid to gel to rubber to hard plastic. Silicone and siloxane-based materials are utilized in myriad end use applications and environments, including as components in a wide variety of industrial, home care, and personal care formulations.

Silicone and siloxane-based materials are known in the art and are utilized in myriad end use applications and environments. The most common silicone materials are based on the linear organopolysiloxane polydimethylsiloxane (PDMS), a silicone oil. Such organopolysiloxanes are utilized in numerous industrial, home care, and personal care formulations. The second largest group of silicone materials is based on silicone resins, which are formed with branched and cage-like oligosiloxanes. Unfortunately, the use of siloxane-based materials in certain applications that may benefit from particular inherent attributes of organopolysiloxanes (e.g. low-loss and stable optical transmission, thermal and oxidative stability, etc.) remains limited due to the weak mechanical properties of conventional silicone networks suitable for functionalization and/or further reaction, which may manifest in materials with poor or unsuitable characteristics such as low tensile strength, low tear strength, etc. Moreover, as conventional silicone networks and carbon-based polymers are often incompatible and/or possess antagonistic properties with respect to one another, additional research is needed to identify useful ways for efficiently and effectively functionalizing silicones, such as silicone resins.

For example, many conventional silicone materials (e.g. siloxanes, silicone resins) are hydrophobic, and are thus difficult to mix with polar organic materials under a wide range of conditions. As such, these silicone materials are typically utilized in either solid forms or, where a solution/dispersion is necessary, with apolar organic (e.g. hydrocarbon) solvents such as benzene, toluene, ethylbenzene, and xylenes (i.e., BTEX solvents). Unfortunately, such conditions are also often incompatible with certain polar organic materials, as well as the process conditions necessary for their use. Moreover, the nature of BTEX solvents, which present numerous environmental and health-related concerns, necessitates further exploration for safe and effective use of silicone materials in nontraditional applications.

### BRIEF SUMMARY OF THE INVENTION

A liquid silicone resin composition (the “composition”) is disclosed. The composition comprises (A) a polysiloxane having the following general formula:

(R¹₃SiO_{1/2})ₐ(R²₂SiO_{2/2})_{b}(R′R²SiO_{2/2})_{b′}(R²SiO_{3/2})_{c}(R′SiO_{3/2})_{c′}(SiO_{4/2})_{d},

wherein subscripts a, b, b′, c, c′ and d are each mole fractions such that a+b+b′+c+c′+d=1, with the provisos that 0<a<1, 0≤b<0.2, 0≤b′≤0.1 0<c<0.2, 0≤c′≤0.1, 0<d<1, 0≤b′+c′≤0.1, and the ratio of subscript a to subscript d is from 0.5 to 1.5 (a:d); each R¹ is independently selected from hydrocarbyl groups having from 1 to 30 carbon atoms, —OH, and H; each R² is independently selected from R¹ and —OX, where each X is independently H, a hydrocarbyl group R having from 1 to 30 carbon atoms, or a polyether moiety having the general formula —Y—R³(—[Y]ⱼ—Z)ᵢ, wherein R³ is a substituted or unsubstituted hydrocarbon segment, each Y is an independently selected oxyalkylene segment of general formula (CₙH₂ₙO)ₘ, where subscript m is from 1 to 50 and subscript n is independently selected from 2 to 4 in each moiety indicated by subscript m, each Z is independently H or a resinous silicone moiety, subscript i is from 0 to 8, and subscript j is independently 0 or 1 in each moiety indicated by subscript i; and each R′ comprises an independently selected amino group. The composition also comprises (B) a polyether alcohol compound having the general formula HO—Y—R³(—[Y]ⱼ—Z)ᵢ, wherein each Y, R³, Z, subscript j, and subscript i are as defined above.

A method of preparing the liquid silicone resin composition is also disclosed. The method comprises (I) combining together a solid silicone resin and the polyether alcohol compound (B) to give a mixture comprising the polysiloxane (A) and the polyether alcohol compound (B). The solid silicone resin has the following general formula:

(R¹₃SiO_{1/2})ₐ(R⁴₂SiO_{2/2})_{b}(R⁴SiO_{3/2})_{c}(SiO_{4/2})_{d},

where each R⁴ is independently selected from R¹ and —OR, with the proviso that R⁴ is selected from —OH and —OR in at least one T siloxy unit indicated by subscript c, and each R¹, R, and subscripts a, b, c, and d are as defined above. The method also comprises (II) liquefying the mixture comprising the polysiloxane (A) and the polyether alcohol compound (B), thereby preparing the liquid silicone resin composition. The method may optionally utilize (C) an aminosilicon compound.

### DETAILED DESCRIPTION OF THE INVENTION

A liquid silicone resin composition (the “composition”) is provided herein, along with a method of preparing the same. As will be understood from the description herein, the composition provides a functional MQ resin, optionally capped with one or more polyether-containing moieties, in a liquid form without need for solvents or other carrier vehicles. By “liquid”, it is meant that the composition is flowable and has a viscosity that can be measured at 25° C. The particular materials and conditions utilized provide the composition with a highly-tunable liquid viscosity, thereby providing the composition numerous uses in myriad compositions and methods, including in preparing curable compositions (e.g. such as those based on one or more silicones) and various components thereof. Moreover, owing to the unique structural features, the liquid composition may be suitable for dispersion into water, polyols, or other polar liquid formulations (e.g. those containing anionic and/or non-ionic surfactants).

The composition generally includes (A) a polysiloxane, (B) a polyether alcohol compound, and optionally (C) an aminosilicon compound, which are described in turn below, along with additional compounds that may be present in the composition which may be collectively referred to herein as the “components” of the composition (i.e., “component (A)”, “component (B)”, etc., respectively.) or, likewise, as “compound(s),” and/or “reagent(s)” (A) and/or (B), etc.

As understood by those of skill in the art, siloxanes may be characterized in terms of [M], [D], [T], and/or [Q] units/siloxy groups therein. More specifically, these [M], [D], [T], and [Q] siloxy groups each represent structural units of individual functionality present in polysiloxanes, such as organosiloxanes and organopolysiloxanes. In particular, [M] represents a monofunctional unit of general formula R″₃SiO_{1/2}; [D] represents a difunctional unit of general formula R″₂SiO_{2/2}; [T] represents a trifunctional unit of general formula R″SiO_{3/2}; and [Q] represents a tetrafunctional unit of general formula SiO_{4/2}, as shown by the general structural moieties below:

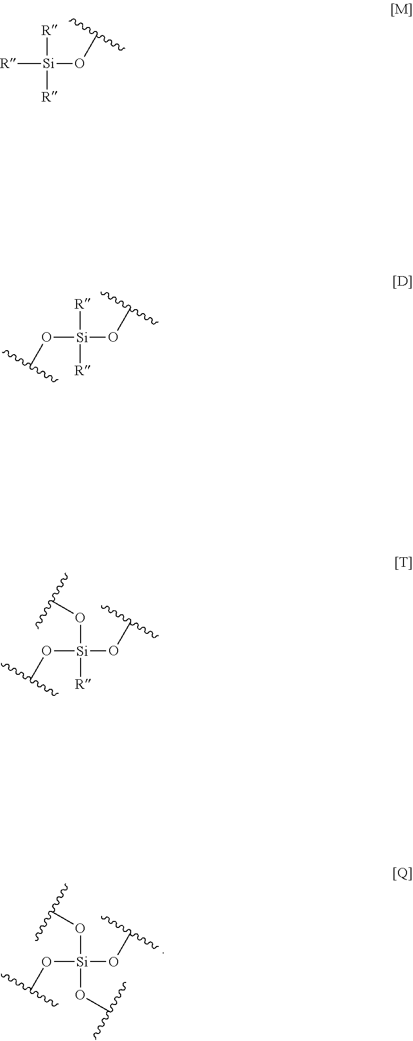

In these general structural moieties, each R″ is independently a monovalent or polyvalent substituent. As understood in the art, specific substituents suitable for each R″ are not particularly limited, and may be monoatomic or polyatomic, organic or inorganic, linear or branched, substituted or unsubstituted, aromatic, aliphatic, saturated or unsaturated, and combinations thereof. Typically, each R″ is independently selected from hydrocarbyl groups, alkoxy and/or aryloxy groups, and siloxy groups, such as those represented by any one, or combination, of [M], [D], [T], and/or [Q] units described above.

As introduced above, the composition comprises the polysiloxane (A). As will be appreciated in view of the description herein, the polysiloxane (A) may be categorized or otherwise referred to as an MQ resin where, as introduced above, M designates monofunctional siloxy units (i.e., R″₃SiO_{1/2}, with R″ representing a silicon-bonded substituent) and Q designates tetrafunctional siloxy units (i.e., SiO_{4/2}). Such MQ resins are known in the art as macromolecular polymers composed primarily of M and Q units and, optionally a limited number of D and/or T units (e.g. s 20 mole %, total), and typically present in/as a solid (e.g. powder or flake) form unless disposed in a solvent. These MQ resins are often designated simply by the general formula [M]ₓ[Q] where subscript x refers to the molar ratio of M siloxy units to Q siloxy units when the number of moles of Q siloxy units is normalized to 1. In such instances, the greater the value of x, the lesser the crosslink density of MQ resin. The inverse is also true as, when the value of x decreases, the number of M siloxy units decreases, and thus more Q siloxy units are networked without termination via an M siloxy unit. It will be appreciated, however, that the normalized content of Q siloxy units does not imply or limit MQ resins to only one Q unit. Rather, MQ resins typically includes a plurality of Q siloxy units clustered or bonded together, as will be appreciated from the description below.

Typically, the polysiloxane (A) has the following general formula:

(R¹₃SiO_{1/2})ₐ(R²₂SiO_{2/2})_{b}(R′R²SiO_{2/2})_{b′}(R²SiO_{3/2})_{c}(R′SiO_{3/2})_{c′}(SiO_{4/2})_{d},

wherein subscripts a, b, b′ c, c′, and d are each mole fractions such that a+b+b′+c+c′+d=1, with the provisos that 0<a<1, 0≤b<0.2, 0≤b′≤0.1, 0<c<0.2, 0≤c′≤0.1; 0<d<1, 0≤b′+c′≤0.1, and the ratio of subscript a to subscript d is from 0.5 to 1.5 (a:d); each R¹ is independently selected from hydrocarbyl groups having from 1 to 30 carbon atoms, —OH, and H; each R² is independently selected from R¹ and —OX, where each X is independently H, a hydrocarbyl group R having from 1 to 30 carbon atoms, or a polyether moiety as described below; and each R′ comprises an independently selected amino group.

With reference to the general formula of the polysiloxane (A) above, hydrocarbyl groups suitable for R¹ include monovalent hydrocarbon moieties, as well as derivatives and modifications thereof, which may independently be substituted or unsubstituted, linear, branched, cyclic, or combinations thereof, and saturated or unsaturated. With regard to such hydrocarbyl groups, the term “unsubstituted” describes hydrocarbon moieties composed of carbon and hydrogen atoms, i.e., without heteroatom substituents. The term “substituted” describes hydrocarbon moieties where either at least one hydrogen atom is replaced with an atom or group other than hydrogen (e.g. a halogen atom, an alkoxy group, an amine group, etc.) (i.e., as a pendant or terminal substituent), a carbon atom within a chain/backbone of the hydrocarbon is replaced with an atom other than carbon (e.g. a heteroatom, such as oxygen, sulfur, nitrogen, etc.) (i.e., as a part of the chain/backbone), or both. As such, suitable hydrocarbyl groups may comprise, or be, a hydrocarbon moiety having one or more substituents in and/or on (i.e., appended to and/or integral with) a carbon chain/backbone thereof, such that the hydrocarbon moiety may comprise, or be, an ether, an ester, etc. Linear and branched hydrocarbyl groups may independently be saturated or unsaturated and, when unsaturated, may be conjugated or nonconjugated. Cyclic hydrocarbyl groups may independently be monocyclic or polycyclic, and encompass cycloalkyl groups, aryl groups, and heterocycles, which may be aromatic, saturated and nonaromatic and/or non-conjugated, etc. Examples of combinations of linear and cyclic hydrocarbyl groups include alkaryl groups, aralkyl groups, etc. General examples of hydrocarbon moieties suitably for use in or as the hydrocarbyl group include alkyl groups, aryl groups, alkenyl groups, alkynyl groups, halocarbon groups, and the like, as well as derivatives, modifications, and combinations thereof. Examples of alkyl groups include methyl, ethyl, propyl (e.g. iso-propyl and/or n-propyl), butyl (e.g. isobutyl, n-butyl, tert-butyl, and/or sec-butyl), pentyl (e.g. isopentyl, neopentyl, and/or tert-pentyl), hexyl, and the like (i.e., other linear or branched saturated hydrocarbon groups, e.g. having greater than 6 carbon atoms). Examples of aryl groups include phenyl, tolyl, xylyl, naphthyl, benzyl, dimethyl phenyl, and the like, as well as derivatives and modifications thereof, which may overlap with alkaryl groups (e.g. benzyl) and aralkyl groups (e.g. tolyl, dimethyl phenyl, etc.). Examples of alkenyl groups include vinyl, allyl, propenyl, isopropenyl, butenyl, isobutenyl, pentenyl, heptenyl, hexenyl, cyclohexenyl groups, and the like, as well as derivatives and modifications thereof. General examples of halocarbon groups include halogenated derivatives of the hydrocarbon moieties above, such as halogenated alkyl groups (e.g. any of the alkyl groups described above, where one or more hydrogen atoms is replaced with a halogen atom such as F or Cl), aryl groups (e.g. any of the aryl groups described above, where one or more hydrogen atoms is replaced with a halogen atom such as F or Cl), and combinations thereof. Examples of halogenated alkyl groups include fluoromethyl, 2-fluoropropyl, 3,3,3-trifluoropropyl, 4,4,4-trifluorobutyl, 4,4,4,3,3-pentafluorobutyl, 5,5,5,4,4,3,3-heptafluoropentyl, 6,6,6,5,5,4,4,3,3-nonafluorohexyl, and 8,8,8,7,7-pentafluorooctyl, 2,2-difluorocyclopropyl, 2,3-difluorocyclobutyl, 3,4-difluorocyclohexyl, 3,4-difluoro-5-methylcycloheptyl, chloromethyl, chloropropyl, 2-dichlorocyclopropyl, 2,3-dichlorocyclopentyl, and the like, as well as derivatives and modifications thereof. Examples of halogenated aryl groups include chlorobenzyl, pentafluorophenyl, fluorobenzyl groups, and the like, as well as derivatives and modifications thereof.

In certain embodiments, at least one R¹ is a substituted or unsubstituted hydrocarbyl group having from 1 to 30 carbon atoms. For example, in some such embodiments, the at least one R¹ is an independently selected substituted or unsubstituted alkyl group, such as an alkyl group having from 1 to 24, alternatively from 1 to 18, alternatively from 1 to 16, alternatively from 1 to 12, alternatively from 1 to 10, alternatively from 1 to 8, alternatively from 1 to 6, carbon atoms. Specific examples of alkyl groups include methyl groups, ethyl groups, propyl groups (e.g. n-propyl and iso-propyl groups), butyl groups (e.g. n-butyl, sec-butyl, isobutyl, and tert-butyl groups), pentyl groups, hexyl groups, heptyl groups, etc., and the like, as well as derivatives and/or modifications thereof. Examples of derivatives and/or modifications of such alkyl groups include substituted versions thereof. For example, R¹ may comprise, alternatively may be, a hydroxyl ethyl group, which will be understood to be a derivative and/or a modification of the ethyl groups described above. Likewise, R¹ may comprise, alternatively may be, an independently selected substituted or unsubstituted alkenyl groups having from 2 to 6 carbon atoms, such as from 2 to 5, alternatively from 2 to 4, alternatively from 2 to 3 carbon atoms. In certain embodiments, the polysiloxane (A) comprises at least two R¹ groups comprising alkenyl functionality (i.e., at least two R¹ are selected from substituted or unsubstituted alkenyl groups). In these or other embodiments, each R¹ is independently selected from H, —OH, C1-C6 alkyl groups, aryl groups, alkenyl groups, phenyl groups, vinyl groups, and combinations thereof. In certain embodiments, at least 50, alternatively at least 60, alternatively at least 70, alternatively at least 80, alternatively at least 90, mol % of all R¹ groups are hydrocarbyl groups.

With continued reference to the general formula of the polysiloxane (A) above, each R² is independently selected from R¹ and —OX, where each X is independently H (i.e., such that R² is a hydroxy group), the hydrocarbyl group R having from 1 to 30 carbon atoms (i.e., such that R² is a hydrocarbyloxy group of formula —OR), or a polyether moiety. Where X is the hydrocarbyloxy group, the hydrocarbyl group R may be selected from any of the hydrocarbyl groups having from 1 to 30 carbon atoms set forth above. As such, examples of hydrocarbyloxy groups suitable for X include alkoxy and aryloxy groups. Examples of alkoxy groups include methoxy, ethoxy, propoxy, butoxy, benzyloxy, and the like, as well as derivatives and modifications thereof. Examples of aryloxy groups include phenoxy, tolyloxy, pentafluorophenoxy, and the like, as well as derivatives and modifications thereof. In some embodiments, each R² is independently selected from R¹ and —OR, where each R¹ is independently selected from H, —OH, and alkyl and aryl groups containing 1 to 30 carbon atoms, and each R is independently selected from alkyl and aryl groups containing 1 to 30 carbon atoms. In these or other embodiments, each R² is independently selected from —OH and —OR, where each R is independently selected from alkyl and aryl groups containing 1 to 30 carbon atoms.

As introduced above, in certain embodiments, at least one R² is of formula and —OX, where X is the polyether moiety. In these embodiments, the polyether moiety is not particularly limited, and generally comprises an oxyalkylene segment of general formula (CₙH₂ₙO)ₘ, where subscript m is from 1 to 50 and subscript n is independently 2, 3, or 4 in each moiety represented by subscript m. In certain embodiments, subscript m is from 1 to 45, such as from 1 to 40, alternatively from 1 to 30, alternatively from 1 to 25, alternatively from 1 to 20, alternatively from 1 to 15. In specific embodiments, subscript m is at least 2, such that the polyoxyalkylene moiety may comprise one or more oxyalkylene units selected from oxyethylene units (e.g. —(C₂H₄O)—, i.e., where subscript n is 2), oxypropylene units (e.g. —(C₃H₆O)—, i.e., where subscript n is 3), and oxybutylene units (e.g. —(C₄H₈O)—, i.e., where subscript n is 4). When the oxyalkylene segment comprises more than one type of oxyalkylene unit (i.e., is a polyoxyalkylene), the oxyalkylene units may be arranged in any fashion, such as in block form (e.g. ordered blocks and/or random blocks), randomized form, or combinations thereof. In specific embodiments, the oxyalkylene segment comprises both oxyethylene and oxypropylene units. In some such embodiments, the oxyalkylene segment is an oxyethylene-oxypropylene block copolymer.

The polyether moiety may comprise more than one oxyalkylene segment. For example, in certain embodiments, X comprises a polyether moiety having the general formula —Y—R³(—[Y]ⱼ—Z)ᵢ, wherein R³ is a substituted or unsubstituted hydrocarbon segment, each Y is an independently selected oxyalkylene segment of general formula (CₙH₂ₙO)ₘ as described above, Z is a terminal group, subscript i is from 0 to 8, and subscript j is independently 0 or 1 in each moiety indicated by subscript i. In these embodiments, R³ is an at least divalent hydrocarbon linking group. More specifically, as used herein in this context, the valency of the hydrocarbon segment R³ refers to the number of substituents of subformula (—[Y]ⱼ—Z) bonded thereto in addition to the oxyalkylene segment Y. As such, the valency of the hydrocarbon segment R³ in this context may be described as subscript i+1.

Typically, each hydrocarbon segment R³ independently comprises one or more substituted or unsubstituted hydrocarbon groups, i.e., a hydrocarbon group that is optionally modified or substituted, e.g. with pendant alkoxy, carbonyl, siloxy, silyl, amino, amido, acetoxy, or aminoxy groups and/or internal O, N, or S atoms (i.e., in the backbone). For example, in some embodiments, the polysiloxane (A) comprises at least one X corresponding to the general polyether moiety formula above, where the hydrocarbon segment R³ comprises, alternatively is, a linear or branched hydrocarbon group having from 3 to 30 carbon atoms, optionally comprising one or more aromatic groups, ether groups, amine groups, or a combination thereof. In some such embodiments, the hydrocarbon segment R³ is a C1-C20 hydrocarbon group. In these or other embodiments, each hydrocarbon segment R³ independently comprises an aromatic group, an ether group, an amine group, or a combination thereof. As will be appreciated from the description herein, the ether and amine groups of the hydrocarbon segment R³ set forth above may be internal (e.g. comprising an 0 or N atom in the backbone of the linear or branched hydrocarbon group) or pendant (e.g. comprising an alkoxy or amine group bonded to the backbone of the linear or branched hydrocarbon group).

Each hydrocarbon segment R³ may be independently linear or branched. More specifically, as will be appreciated from the description herein, R³ typically comprises up to i number of branches (i.e., from 0 to 8 branches), where subscript j is 1 for each branch off from R³ to the terminal group Z. In certain embodiments, each hydrocarbon segment R³ comprises a branched hydrocarbon group having from 3 to 16 carbon atoms. In some embodiments, each oxyalkylene segment Y independently has the formula (C₂H₄O)ₓ(C₃H₆O)_{y}(C₄H₈O)_{z}, where subscript x is from 1 to 50, subscript y is from 0 to 50, and subscript z is from 0 to 50, and where units indicated by subscripts x, y and z may be in randomized or block form in the oxyalkylene segment.

In some embodiments, the polysiloxane (A) comprises at least one X corresponding to the general polyether moiety formula above, where subscript i is 0 and each hydrocarbon segment R³ independently comprises a linear or branched hydrocarbon group having from 3 to 30 carbon atoms. In these or other embodiments, the polysiloxane (A) comprises at least one X where subscript i is 1 and the hydrocarbon segment R³ comprises at least one group selected from linear or branched hydrocarbon groups having from 3 to 30 carbon atoms, phenols, tetrahydrofurans, and alkyl amines, each optionally substituted with one or more alkoxy groups. In these or other embodiments, the polysiloxane (A) comprises at least one X where subscript i is at least 2, and the hydrocarbon segment R³ comprises at least one group selected from linear or branched hydrocarbon groups having from 3 to 30 carbon atoms, alkyl amines, polyamines, polyamides, polyaziridines, polyphenols, and polyesters.

Typically, each terminal group Z is independently selected from H (i.e., such that the polyether moiety is terminally hydroxy-functional) or a resinous silicone moiety (i.e., from condensation of terminal hydroxy-functionality with a condensable silicon-bonded moiety of the polysiloxane (A)). For example, where subscript i is at least 1, the terminal group Z may represent a cross-link to another silanol group of the polysiloxane (A). Similarly, when i>1, the polysiloxane (A) may comprise more than one cross-link. One of skill in the art will appreciate that the presence of such cross-linking in, as well as the cross-linking density of, the polysiloxane (A) in the composition depends on many factors, such as the hydroxyl (e.g. silanol) functionality of the silicone resin selected, the functionality of the polyether alcohol compound (B) selected, the ratio of silicone resin to polyether alcohol compound (B) utilized to prepare the composition, the degree of conversion, etc., as described below with respect to the method. Likewise, the presence of such cross-linking can be ascertained by methods known in the art, such as via rheological measurements of gel points due to the increase of average molecular weights in response to cross-linking (i.e., where the gel point indicates the weight-average molecular weight diverging toward infinity). For example, a rheometer (e.g. a rheometrics mechanical spectrometer using parallel plate geometry) may be utilized to carry out a frequency sweep experiment to determine dynamic storage modulus, equilibrium modulus, and changes in moduli during preparation of the composition. The full scope of the terminal group Z, as well as the potential for cross-linking of the polysiloxane (A), will be better appreciated in view of the method described herein.

Each R′ independently comprises an amino group. In certain embodiments, each R′ is an amino group. The amino group of R′ may be of formula —N(H)_{f}R_{2-f}, where each R is independently selected and defined above, i.e., each R is an independently selected hydrocarbyl group, and where subscript f is independently 0, 1, or 2. In other embodiments, each R′ independently comprises a hydrocarbon group substituted with an amino group.

Suitable hydrocarbon groups are described above. In specific embodiments, each R′ independently comprises an aliphatic hydrocarbon group substituted with an amino group.

The aliphatic hydrocarbon group can be linear or cyclic, and is typically saturated. In specific embodiments, each R′ comprises an alkylamino group. For example, each R′ can be of formula —(CH₂)_{g}N(H)_{f}R_{2-f}, where each subscript g is independently from 1 to 30, alternatively from 1 to 25, alternatively from 1 to 20, alternatively from 1 to 15, alternatively from 1 to 10, alternatively from 1 to 8, alternatively from 1 to 6, alternatively from 1 to 4, alternatively from 2 to 4, and R′ and subscript f are defined above. In specific embodiments, subscript g is 3 and subscript f is 2 such that each R′ is of formula —(CH₂)₃N(H)₂.

With continued reference to the general formula of the polysiloxane (A) above, subscripts a, b, b′, c, c′, and d are each mole fractions such that a+b+b′+c+c′+d=1. As will be appreciated by those of skill in the art, subscripts a, b, c, d, and e correspond to M, D, T, and Q siloxy units, respectively. Both of subscripts b and b′ in the general formula above indicate D siloxy units, and both of subscripts c and c′ in the general formula above indicate T siloxy units, but with different silicon-bonded substituents (R² vs. R′), respectively. In general, fraction of each siloxy unit is selected such that 0<a<1, 0≤b<0.2, 0≤b′≤0.1, 0<c<0.2, 0≤c′≤0.1, 0<d<1, and 0≤b′+c′≤0.1, i.e., where the polysiloxane (A) is optionally free from D siloxy units (including those represented by subscripts b and/or b′), optionally free from T siloxy units indicated by subscript c′, but comprises at least one each of M, T, and Q siloxy units (as indicated by subscripts a, c, and d). It will be appreciated, however, that in such embodiments, the polysiloxane (A) will generally be configured such that R² is —OX in at least one, alternatively the majority, alternatively substantially all of, the T siloxy units indicated by subscript c and present therein. Likewise, while optionally free from D siloxy units, the polysiloxane (A) may comprise a limited proportion of D siloxy units. Typically, however, subscripts b and c are less than 0.2, collectively (i.e., b+c:0.2). In certain embodiments, subscript a is selected to be from 0.3 to 0.6. In these or other embodiments, subscript d is selected to be from 0.4 to 0.7. In specific embodiments, subscript c′ is 0. In other embodiments, subscript c′ is from greater than 0 to 0.1, alternatively from greater than 0 to 0.05, alternatively from greater than 0 to 0.04, alternatively from 0.01 to 0.04. In other specific embodiments, subscript b′ is 0. In yet other embodiments, subscript b′ is from greater than 0 to 0.1, alternatively from greater than 0 to 0.05, alternatively from greater than 0 to 0.04, alternatively from 0.01 to 0.04. In further embodiments, b′ and c′ are each 0. In other embodiments, (b′+c′) is from greater than 0 to 0.1, alternatively from greater than 0 to 0.05, alternatively from greater than 0 to 0.04, alternatively from 0.01 to 0.04.

It will be appreciated that subscripts a and d generally refer to the MQ resinous portion of the polysiloxane (A), such that the ratio of subscript a to subscript d may be used to characterize the polysiloxane (A). For example, in some embodiments, the ratio of M siloxy units indicated by subscript a to Q siloxy units indicated by subscript d is from 0.5 to 1.5 (a:d). In these or other embodiments, the ratio of M siloxy units indicated by subscript a to Q siloxy units indicated by subscript d is from 0.7 to 1.2 (a:d).

As will be appreciated in view of the method further below, the features and properties of the polysiloxane (A) will be selected and controlled by the particular components utilized in preparing the liquid silicone resin composition as a whole.

As introduced above, the composition also comprises the polyether alcohol compound (B). Typically, the polyether alcohol compound (B) has the general formula HO—Y—R³(—[Y]ⱼ—H)ᵢ, where each Y, R³, subscript i, and subscript j are as defined above. More specifically, R³ is a substituted or unsubstituted hydrocarbon segment, each Y is an independently selected oxyalkylene segment, subscript i is from 0 to 8, and subscript j is independently 0 or 1 in each moiety indicated by subscript i. Additional description and examples of the polyether alcohol compound (B) are provided below. However, as will be appreciated in further detail in view of the method described herein, the groups indicated by Y and R³ in the general formula of the polyether alcohol compound (B) are the same (i.e., in terms of scope) as those same groups indicated above with respect to the polyether moiety of the polysiloxane (A). As such, the description of each Y and R³, as well as the moieties indicated by subscripts j and i, applies equally to the conserved portions of the formulae of both the polyether moiety of the polysiloxane (A) and the polyether alcohol compound (B).

In general, the polyether alcohol compound (B) comprises the alkoxylation reaction product of (b-1) a compound comprising at least one alkoxylatable group (e.g. a functional group comprising a labile hydrogen atom bonded to a nucleophilic O, N, or S atom, such as an —OH, —NH, or SH group) (i.e., an alkoxylatable compound (b-1)), and (b-2) an alkoxylation agent (e.g. an alkylene oxide, polyoxyalkylene compound, etc.) which are described in turn below. As will be understood by those of skill in the art, the alkoxylation reaction is not limited, and will be selected in view of the particular alkoxylatable compound (b-1) and alkoxylation agent (b-2) utilized.

Typically, the alkoxylatable compound (b-1) is an organic alcohol, i.e., an organic compound comprising a carbon backbone and at least one hydroxyl (i.e., —OH) group. In such embodiments, the alkoxylatable compound (b-1) may be referred to more specifically as an alcohol compound (b-1). As will be understood in view of the examples and description below, the alcohol compound (b-1) may be a mono-ol (i.e., comprise but one hydroxyl functional group) or a polyol (i.e., comprise at least two hydroxyl groups), such as a diol, triol, etc. The carbon backbone of the alcohol compound (b-1) may be substituted or unsubstituted, e.g. with any of the functional groups described herein. When substituted, the carbon backbone of the alcohol compound (b-1) may comprise pendant substitutions (i.e., in place of hydrogen atoms attached to the carbon backbone) or substitutions of carbon atoms within the backbone itself (e.g. by other heteroatoms, such as O, S, N, etc.). As such, it is to be appreciated that, while characterized or otherwise referred to as an organic alcohol, the alcohol compound (b-1) may be alternatively or further defined in view of additional functionality when present (e.g. as an amino alcohol, etc.). Additionally, the carbon backbone may be linear or branched, and may thus comprise linear, branched, and/or cyclic hydrocarbon segments.

As will be understood in view of the description herein, the alcohol compound (b-1) typically corresponds to the general formula HO—R³(—OH)ᵢ, where R³ and subscript i are as defined above. More specifically, R³ is a hydrocarbon segment and subscript i is from 0 to 8. In such embodiments, it will be appreciated that the hydrocarbon segment R³ represents the carbon backbone of the alcohol compound (b-1), which, as indicated by subscript i, may comprise may comprise from 0 to 8 hydroxyl groups in addition to the required hydroxyl group.

In certain embodiments, subscript i is 0, such that the alcohol compound (b-1) is an alcohol of general formula HO—R³. In some such embodiments, R³ comprises, alternatively is, a linear or branched hydrocarbon group having from 3 to 30 carbon atoms. For example, in some embodiments, R³ is a branched hydrocarbon group having from 3 to 30 carbon atoms.

In some such embodiments, alcohol compound (b-1) has the formula:

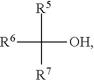

where R⁵, R⁶, and R⁷ are independently selected from C1-C13 alkyl groups. For example, in some such embodiments, R⁵ and R⁶ are each independently selected from C1-4 alkyl groups, and R⁷ is H or a C1-C13 alkyl group. In some of these embodiments, R³ comprises a total of from 7 to 16 carbon atoms, such as from 9 to 12 carbon atoms. In some embodiments, R³ comprises a branching degree of at least 3. In this context, the term “branching degree” as used herein means the total number of methyl (—CH₃) groups minus 1. For instance, an R³ comprising an alkyl group comprising four methyl group substituents comprises a branching degree of 3. In some embodiments, R⁵ is an alkyl group comprising from 3 to 12 carbon atoms, such a C3-C8 alkyl group, or, alternatively, a C4-C6 alkyl group. In such embodiments, R⁵ comprises at least 2 methyl groups. In these or other embodiments, R⁶ is an alkyl group comprising from 3 to 12 carbon atoms, such as a C4-C10 alkyl group, alternatively a C6-C8 alkyl group. In some embodiments, R⁷ comprises at least 2 methyl groups. For example, in certain embodiments, R⁷ is a C1-C3 alkyl group. In other embodiments, R⁷ is H. In some embodiments, R⁵ is CH₃(CH₂)₂CH(CH₃)(CH₂)₂CH(CH₃), and R⁶ is H, and R⁷ is CH₃. In specific embodiments, the alcohol compound (b-1) is (3-methyl-6-ethyl)-2-nonanol.

In certain embodiments, subscript i is 1, such that the alcohol compound (b-1) is a diol of general formula HO—R³—OH, where the hydrocarbon segment is a divalent linking group. In certain embodiments, for example, R³ comprises, alternatively is, an alkyl group (i.e., such that the alcohol compound (b-1) is a glycol) or substituted alkyl group (e.g. a diethylamino group, such that the alcohol compound (b-1) is a diethanolamine), an aryl group (e.g. a phenyl, benzyl, tolyl, etc.), a tetrahydrofuran group, or other difunctional materials, such as those derived from ring opening of epoxy adducts or alkoxy diols.

In particular embodiments, subscript i is 2, such that the alcohol compound (b-1) may be further defined as a polyol, such as a triol, tetraol, etc. In such embodiments, the alcohol compound (b-1) is exemplified by glycerols, pentaerythritols, sugar alcohols (e.g. sorbitol, xylitol, mannitol, etc.), and the like. In some such embodiments, R³ comprises, alternatively is selected from alkyl amines, polyamines, polyamides, polyaziridines, polyphenols, and polyesters. In some embodiments, for example, R³ comprises, alternatively is, a phenol formaldehyde resin, an epoxy adduct of a glycidyl ether with a polyol, an epoxy adduct of a glycidyl ether with a diamine or polyamine (e.g. such as a secondary diamine). In any of such embodiments, subscript i may be from 2 to 8, such that alcohol compound (b-1) comprises from 2 to 8 hydroxyl groups, such as from 3 to 8, alternatively 3 to 6, alternatively from 3 to 5, hydroxyl groups.

It is to be appreciated that the other polyols and alcohols may be used as the alcohol compound (b-1) to prepare the polyether alcohol compound (B) as well. For example, in certain embodiments, the alcohol compound (b-1) is selected from polyether polyols, polyester polyols, polycarbonate polyols, acrylic polyols, polyols derived from isocyanate pre-polymers (e.g. those having a functionality from 2 to 8, etc.), and the like.

The alkoxylation agent (b-2) is not limited, and may be or include any alkoxylation compound suitable for substituting the alkoxylatable compound (b-1) to give the polyether alcohol compound (B) as described herein. Typically, the alkoxylation agent (b-2) is selected from alkylene oxides, polyoxyalkylene compounds, and combinations thereof. For example, in certain embodiments, the alkoxylation agent (b-2) is selected from ethylene oxide, propylene oxide, butylene oxide, and combinations thereof. In other embodiments, the alkoxylation agent (b-2) is selected from polyoxyethylenes, polyoxypropylenes, polyoxybutylenes, and combinations thereof (e.g. in the form of random or block polymers).

One of skill in the art will appreciate that the term “alkoxylation” as used herein, e.g. with regard to precursors (b-1) and (b-2) of the polyether alcohol compound (B), may be considered functional and/or descriptive, and includes ethers/etherification products as well.

It will be appreciated by those of skill in the art that the number of hydroxyl groups present on the alkoxylatable compound (b-1) will influence the overall structure of the polyether alcohol compound (B) itself. In particular, the polyether alcohol compound (B) may comprise up to i=1 polyoxyalkylene groups, i.e., from alkoxylating the alkoxylatable group(s) of the alcohol compound (b-1) with the alkoxylation agent (b-2).

With regard to the polyether alcohol compound (B) itself, e.g. corresponding to the general formula HO—Y—R³(—[Y]ⱼ—H)ᵢ, each oxyalkylene segment Y may independently have the formula (C₂H₄O)ₓ(C₃H₆O)_{y}(C₄H₈O)_{z}, where subscript x is from 1 to 50, subscript y is from 0 to 50, and subscript z is from 0 to 50, and where units indicated by subscripts x, y and z may independently be in randomized or block form in each oxyalkylene segment. In certain embodiments, in each oxyalkylene segment Y, subscript x is from 1 to 20, subscript y is from 0 to 20, and subscript z is from 0 to 20. In some such embodiments, x+y+z=from 1 to 50, such as from 1 to 20, alternatively from 10 to 20. In specific embodiments, subscript x is from 2 to 20, and subscripts y and z are both 0, such that the polyether alcohol compound (B) may be further defined as a polyoxyethylene alcohol.

In certain embodiments, the polyether alcohol compound (B) is a nonionic surfactant.

For example, in some such embodiments, the polyether alcohol compound (B) may be selected from straight-chain linear ethoxylates, branched ethoxylates (e.g. polyethylene glycol p-(1,1,3,3-tetramethylbutyl)-phenyl ether), amine ethyoxylates (e.g. tertiary amine ethoxylates, fatty amine ethoxylates and/or propoxylates), ethoxylyated, propoxylated, and/or butoxylated glycols, and the like.

It will be appreciated from the description above that, in some embodiments, the polyether alcohol compound (B) may have the general formula HO—(C₂H₄O)ₓ(C₃H₆O)_{y}(C₄H₈O)_{z}—CR⁵R⁶R⁷, where R⁵, R⁶, R⁷, and subscripts x, y, and z are as defined above. In some such embodiments, for example, subscript x is from 1 to 40, subscripts y and z are selected such that y+z=1-6, R⁵ and R⁶ are independently selected C1-C4 alkyl groups, and R⁷ is H or C1-C13 alkyl. In some such embodiments, the moiety indicated by sub formula —CR⁵R⁶R⁷ comprises a total of from 7 to 16 carbon atoms and a branching degree of at least 3.

In some embodiments, the polyether alcohol compound (B) has the following formula:

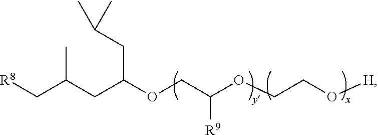

where R⁸ is H or isopropyl; R⁹ is CH₃ or CH₂CH₃; subscript y′ is from 1 to 5, such as from 1 to 4, alternatively from 2 to 4; and subscript x is from 2 to 30, such as from 2 to 20, alternatively from 2 to 10, alternatively from 2 to 9, alternatively from 5 to 9. In some of these embodiments, R⁸ is H and R⁹ is CH₃, such that the polyether alcohol compound (B) has the formula:

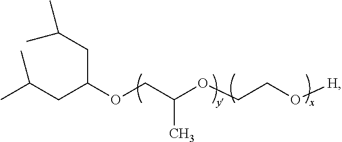

where subscripts y′ and x are as described above. In other embodiments, R⁸ is isopropyl, such that the polyether alcohol compound (B) has the formula:

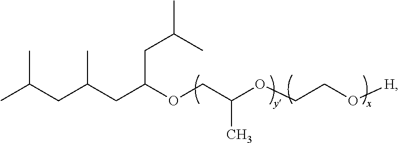

where subscripts y′ and x are as described above.

In general, the polyether alcohol compound (B) may be prepared or otherwise obtained with a narrow molecular weight distribution, as represented the polydispersity index (PDI) (i.e., the weight average molecular weight/number average molecular weight (Mw/Mn), e.g. as determined by gel permeation chromatography). For example, in certain embodiments, the polyether alcohol compound (B) comprises a PDI of 1.15 or less, alternatively of 1.1 or less.

In certain embodiments, the polyether alcohol compound (B) a molecular weight (Mw) of less than 5000, for example a Mw of from 10 to less than 5000, alternatively from 10 to 4500, alternatively from 50 to 4000, alternatively from 100 to 3000, alternatively from 100 to 2000.

In these or other embodiments, the polyether alcohol compound (B) comprises a low level of residual unreacted alkoxylatable compound (b-1), e.g. alcohol compound (b-1) (i.e., un-alkoxylated alcohol). For example, in some embodiments, the polyether alcohol compound (B) contains less than 3 weight percent, alternatively less than 2 wt. %, or less, alternatively 1 wt. % percent or less, alternatively 0.5 wt. % of residual/unreacted alcohol compound (b-1). In certain embodiments, the composition comprises a mixture of more than one polyether alcohol compound (B), such as 2, 3, 4, 5, or more individual polyether alcohol compounds (B), which are independently selected.

The amount of components (A) and (B) in the composition may vary. In some embodiments, for example, the composition comprises from 10 to 80 wt. % of the polysiloxane (A), based on the total weight of the composition. Likewise, in these or other embodiments, the composition comprises from 10 to 95 wt. % of the polyether alcohol compound (B), based on the total weight of the composition. In specific embodiments, the composition comprises from 10 to 80, alternatively from 20 to 80, alternatively from 20 to 70, alternatively from 30 to 70 wt. % of the polysiloxane (A), based on the total weight of the composition. In these embodiments, the balance of the composition may comprise the polyether alcohol compound (B) alone or, alternatively, may comprise a combination of the polyether alcohol compound (B) with one or more additional components of the composition. For example, as will be better understood in view of the method described below, the composition may comprise a catalyst, or a solvent or carrier vehicle. In some embodiments, however, the composition is free from, alternatively substantially free from, a catalyst. In these or other embodiments, the composition is free from, alternatively substantially free from cyclic siloxanes. In these or other embodiments, the composition comprises less than 1 wt. % solvent, based on the total weight of the composition. In other embodiments, the composition is free from, alternatively substantially free from, solvents or carrier vehicles (i.e., aside from component (B) itself).

In certain embodiments, the composition further comprises (C) an aminosilicon compound. Generally, the aminosilicon compound (C) is utilized to impart the D siloxy units indicated by subscript b, if present, and/or the T siloxy units indicated by subscript c′, if present, in the polysiloxane (A), as described below with reference to the method of preparing the composition. Use of the aminosilicon compound (C) when preparing the polysiloxane (A) and/or the composition is optional. When utilized, some residual amount of the aminosilicon compound (C) may be present in the composition, i.e., the aminosilicon compound (C) may not be fully consumed in preparing the polysiloxane (A) and/or the composition.

The aminosilicon compound (C) includes a silicon-bonded substituent comprising an amino group, which can become the substituent indicated by R′ in the polysiloxane (A), if present. Typically, the aminosilicon compound (C) also includes silicon-bonded hydroxyl and/or hydrolysable groups, such as alkoxy groups.

In specific embodiments, the aminosilicon compound (C) comprises, alternatively is, an aminosilane, for example an aminosilane of formula R′R¹⁰ₕSi(OR¹⁰)₃₋ₕ, where subscript h is 0 or 1, R′ is defined above, and each R¹⁰ is an independently selected alkyl group having from 1 to 18, alternatively from 1 to 16, alternatively from 1 to 14, alternatively from 1 to 12, alternatively from 1 to 10, alternatively from 1 to 8, alternatively from 1 to 6, alternatively from 1 to 4, carbon atoms. In one embodiment, subscript h is 0 and the aminosilicon compound (C) is of formula R′Si(OR¹⁰)₃. One specific example of such an aminosilane is 3-propylaminotriethoxysilane. In another embodiment, subscript h is 1 and the aminosilicon compound (C) is of formula R′R¹⁰Si(OR¹⁰)₂. One specific example of such an aminosilane is 3-propylamino(diethoxy)methylsilane.

When the aminosilicon compound (C) is utilized and is of formula R′Si(OR¹⁰)₃, at least some of the aminosilicon compound (C) utilized generally hydrolyses and condenses to give a T siloxy unit in the polysiloxane (A) indicated by subscript c′, i.e., of formula R′SiO_{3/2}.

Typically, each alkoxy group of the aminosilicon compound (C) fully hydrolyzes and condenses to give such a T siloxy unit in the polysiloxane (A). During preparation of the polysiloxane (A), when utilized, the aminosilicon compound (C) may give partial condensate products in a reaction intermediary of the polysiloxane (A). When the aminosilicon compound (C) is utilized and is of formula R′Si(OR¹⁰)₃, the partial condensate products are of formula (R′(OZ)_{q}SiO_{3-q/2}), where subscript q is independently 0, 1, or 2, and each Z is independently H or R¹⁰.

When the aminosilicon compound (C) is utilized and is of formula R′R¹⁰Si(OR¹⁰)₂, at least some of the aminosilicon compound (C) utilized generally hydrolyses and condenses to give a D siloxy unit in the polysiloxane (A) indicated by subscript b′, i.e., of formula R′R²SiO_{2/2}.

Typically, each alkoxy group of the aminosilicon compound (C) fully hydrolyzes and condenses to give such a D siloxy unit in the polysiloxane (A). During preparation of the polysiloxane (A), when utilized, the aminosilicon compound may give partial condensate products in a reaction intermediary of the polysiloxane (A). When the aminosilicon compound (C) is utilized and is of formula R′R¹⁰Si(OR¹⁰)₂, the partial condensate products are of formula R′R¹⁰(OZ)rSiO_{2-r/2}, where subscript r is independently 0 or 1, and each Z is independently H or R¹⁰.

Combinations of different aminosilicon compounds may be utilized together as the aminosilicon compound (C).

The aminosilicon compound (C) is typically present in the composition in an amount of from 0 to 25, alternatively from 0 to 20, alternatively from 0 to 15, wt. % based on the total weight of the composition.

As introduced above, the composition comprises a tunable liquid viscosity. In particular, the composition generally comprises a viscosity at 25° C. of from 100 to 800,000 cps. For example, in certain embodiments, the composition comprises a viscosity of from 185 cps to 700,000 cps, e.g. depending on the particular polyether alcohol compound (B) selected, the ratio of polysiloxane (A) to the polyether alcohol compound (B) utilized, the presence or absence of the aminosilicon compound (C), etc. Moreover, as will be appreciated in view of the method below, the ratio of —OX=polyether moiety to —OX═H within the polysiloxane (A) (i.e., the capping ratio) may also be independently selected and controlled to provide the composition in a liquid form. Because the composition has a tunable liquid viscosity, the viscosity can be selectively controlled based on desired end use applications and properties thereof.

A method of preparing the liquid silicone resin composition is also provided. The method includes (I) combining together a solid silicone resin, the polyether alcohol compound (B), and optionally the aminosilicon compound (C) to give a mixture comprising the polysiloxane (A), the polyether alcohol compound (B), and optionally the aminosilicon compound (C). The method also includes (II) liquefying the mixture comprising the polysiloxane (A) and the polyether alcohol compound (B), thereby preparing the liquid silicone resin composition. As described below, in certain embodiments utilizing the aminosilicon compound (C), the aminosilicon compound (C) is incorporated during and/or after the step of liquefying the mixture.

As will be appreciated from the description herein, the polyether alcohol compound (B) is capable of liquefying the solid silicone resin, optionally without reacting therewith. As such, the solid silicone resin is typically a solid when combined with the polyether alcohol compound (B), optionally in the presence of a carrier vehicle, as described below. The term “solid” is used herein with reference to the solid silicone resin to describe such silicone as having a softening and/or melting point above room temperature, such that, at room temperature, the silicone resin is solid or substantially solid.

The solid silicone resin has the following general formula:

(R¹₃SiO_{1/2})ₐ(R⁴₂SiO_{2/2})_{b}(R⁴SiO_{3/2})_{c}(SiO_{4/2})_{d},

where each R⁴ is independently selected from R¹ and —OR, with the proviso that R⁴ is selected from —OH and —OR in at least one T siloxy unit indicated by subscript c, and each R¹, R, and subscripts a, b, c, and d are as defined above.

With regard to the preceding formula, as will be appreciated by those of skill in the art in view of the description herein, the solid silicone resin utilized in the method forms the siloxane backbone of the polysiloxane (A). As such, the description above with regard to the M, D, T, and Q siloxy units indicated by subscripts a, b, c, and d, respectively, of the polysiloxane (A) applies equally to the solid silicone resin of the method. For example, in certain embodiments, the solid silicone resin comprises an MQ ratio, i.e., a ratio of M siloxy units indicated by subscript a to Q siloxy units indicated by subscript d, of from 0.5 to 1.5 (a:d). In these or other embodiments, the ratio of M siloxy units indicated by subscript a to Q siloxy units indicated by subscript d is from 0.7 to 1.2 (a:d) in the solid silicone resin. However, as readily understood in the art, though the ranges of subscripts a, b, c, and d are applicable to both the solid silicone resin and the polysiloxane (A), each of subscripts a, b, c, and d may independently differ between the solid silicone resin and the polysiloxane (A). For example, when the method of preparing the composition involves liquefaction, certain siloxane bonds may be cleaved to give SiOZ moieties, where Z is independently H or alkyl. To that end, the polysiloxane (A) may have, for example, fewer Q siloxy units than the solid silicone resin on a mole fraction basis. For example, a Q siloxy unit in the solid silicone resin may result in a T(OZ) siloxy unit (i.e., a T siloxy unit having three siloxane bonds and an SiOZ group) in the polysiloxane (A) from cleaving one siloxane bond. The SiOZ groups may remain in the polysiloxane (A), or may condense with the polyether alcohol compound (B) and/or the aminosilicon compound (C), if utilized, to give a functional group in the polysiloxane (A) (i.e., a polyether group and/or an amino group). In certain embodiments, the solid silicone resin has an SiOZ content of from greater than 0 to 10, alternatively from greater than 0 to 8, alternatively from greater than 0 to 6, alternatively from 0.5 to 4, wt. % SiOZ groups.

Typically, the solid silicone resin has a weight-average molecular weight of from 2,000 to 30,000, such as from 3,000 to 30,000, alternatively from 4,000 to 30,000, alternatively from 4,000 to 25,000, alternatively from 5,000 to 25,000, alternatively from 5,000 to 20,000, alternatively from 6,000 to 20,000. As understood by those of skill in the art, weight-average molecular weight may be readily determined in Daltons using triple-detector gel permeation chromatography (e.g. with light-scattering, refractive index and viscosity detectors) against a polystyrene standard.

It will be appreciated that the polyether alcohol compound (B) utilized in the method (e.g. to cap and/or liquefy the polysiloxane (A)) is the same component as described above with respect to the polyether alcohol compound (B) of the composition. As such, the description above with regard to the polyether alcohol compound (B), and the various portions thereof, also applies equally to the method.

As introduced above, the method of preparing the liquid silicone resin composition comprises combining the solid silicone resin and the polyether alcohol compound (B), and optionally, any other components utilized (collectively, the “method components”), to prepare a mixture therewith. As will be understood by those of skill in the art, there is generally no proactive step required beyond combining the reaction components together, although certain processes, which are described below, may be employed. Moreover, while one aspect of the method includes reacting the solid silicone resin and the polyether alcohol compound (B) (e.g. via condensation reaction) to prepare the polysiloxane (A) and thereby give the composition, it is to be appreciated that in another aspect, the method may be utilized to prepare the composition via simply liquefying the polysiloxane (A) in the presence of the polyether alcohol compound (B), without reacting/capping the same.

Further, as described above, the aminosilicon compound (C) may optionally be utilized in the method. When utilized, the aminosilicon compound (C) can be incorporated at any time of the method of preparing the composition. For example, in one embodiment, the aminosilicon compound (C) is combined with the solid silicone resin and the polyether alcohol compound (B) such that the aminosilicon compound (C) is present in the mixture. Alternatively or in addition, the aminosilicon compound (C) can be combined with the mixture after its formation. Further still, the aminosilicon compound (C) can be combined during and/or after liquefaction of the mixture, as described below.

With regard to the method components, the solid silicone resin may be prepared or otherwise obtained, i.e., as a prepared resin. Methods of preparing MQ resins such as the solid silicone resin are known in the art, with suitable precursors and starting materials commercially available from various suppliers. Preparing the solid silicone resin, when part of the method, is typically performed prior to combining the same with the polyether alcohol compound (B). The polyether alcohol compound (B) may also be prepared as part of the method, or otherwise obtained for use therein. In particular embodiments, the polyether alcohol compound (B) is prepared via reacting (e.g. alkoxylating) the alkoxylatable compound (b-1) with the alkoxylation agent (b-2). When selecting the alkoxylation agent (b-2), e.g. where an alkylene oxide is utilized, one of skill in the art will appreciate that propylene oxide and/or butylene oxide may be used to increase the flexibility of the product of the alkoxylation and/or the condensation reaction of the method, and thereby alter the viscosity by increasing the fluidity of the polyether alcohol compound (B) and, optionally, the polysiloxane (A) prepared therewith

Typically, the method components are combined in a vessel or reactor to prepare the composition. The method components may be fed together or separately to the vessel, or may be disposed in the vessel in any order of addition, and in any combination, as exemplified below. The method may further comprise agitating the mixture, e.g. to enhance mixing and contacting together of the method components when combined. Such contacting independently may use other conditions, with (e.g. concurrently or sequentially) or without (i.e., independent from, alternatively in place of) the agitating, and will typically be implemented to assist in preparing the polysiloxane (A) in the mixture and/or liquefying the mixture. Other conditions may be utilized in addition to, or in place of, those described herein, and may be result-effective conditions for enhancing condensation, liquefaction, etc., in the course of the method.

The method may utilize any amount of the method components and, more specifically, may comprise combining the solid silicone resin, the polyether alcohol compound (B), and optionally the aminosilicon compound (C) in varying amounts or ratios contingent on desired properties of the resulting composition and/or characteristics of the starting materials employed. For example, the solid silicone resin and the polyether alcohol compound (B) may be utilized in amounts configured to provide a specific cap ratio (i.e., the molar ratio of silanol functionality of the MQ resin to hydroxyl functionality of the polyether alcohol compound (B)) of the polysiloxane (A) prepared therewith (e.g. a cap ratio of from 0.25 to 1.0, such as from 0.5 to 0.75, etc.). Accordingly, as will be understood by those of skill in the art, the solid silicone resin and the polyether alcohol compound (B) may be utilized in a 1:≥1 molar ratio, favoring either component. For example, the solid silicone resin and the polyether alcohol compound (B) may be utilized in a molar ratio of from 1:10 to 10:1, alternatively of from 1:5 to 5:1, alternatively of from 1:2 to 2:1, alternatively of from 1:1.1 to 1.1:1. As shown, an excess (e.g. slight excess, moderate excess, or gross excess) of either component can also be utilized.

The solid silicone resin, the polyether alcohol compound (B), and optionally the aminosilicon compound (C) may be combined in any order, optionally under shear or mixing. For example, in some embodiments the mixture is prepared by combining together the solid silicone resin and the polyether alcohol compound (B), optionally with any additional components being utilized, e.g. the aminosilicon compound (C). The components may be combined in any order, simultaneously, or any combinations thereof (e.g. in various multi-part compositions which are eventually combined with one another). Likewise, the mixture may be prepared in batch, semi-batch, semi-continuous, or continuous processes, unless otherwise noted herein. Typically, once combined, the components of the mixture are homogenized, e.g. via mixing, which may be performed by any of the various techniques known in the art using any equipment suitable for the mixing. Examples of suitable mixing techniques generally include ultrasonication, dispersion mixing, planetary mixing, three roll milling, etc. Examples of mixing equipment include agitated batch kettles for relatively high-flowability (low dynamic viscosity) compositions, ribbon blenders, solution blenders, co-kneaders, twin-rotor mixers, Banbury-type mixers, mills, extruders, etc., which may be batch-type or continuous compounding-type equipment, and utilized alone or in combination with one or more mixers of the same or different type.

In some embodiments, the solid silicone resin, the polyether alcohol compound (B), and optionally the aminosilicon compound (C) are combined in the presence of a carrier vehicle. The carrier vehicle is not limited and is typically selected for based on the particular solid silicone resin and/or polyether alcohol compound (B) being utilized, a desired end use of the composition, etc. In general, the carrier vehicle comprises, alternatively is, a solvent, a fluid, an oil (e.g. an organic oil and/or a silicone oil), etc., or a combination thereof.

In some embodiments, the carrier vehicle comprises a silicone fluid. The silicone fluid is typically a low viscosity and/or volatile siloxane. In some embodiments, the silicone fluid is a low viscosity organopolysiloxane, a volatile methyl siloxane, a volatile ethyl siloxane, a volatile methyl ethyl siloxane, or the like, or combinations thereof. Typically, the silicone fluid has a viscosity at 25° C. in the range of 1 to 1,000 mm²/sec. Specific examples of suitable silicone fluids include hexamethylcyclotrisiloxane, octamethylcyclotetrasiloxane, decamethylcyclopentasiloxane, dodecamethylcyclohexasiloxane, octamethyltrisiloxane, decamethyltetrasiloxane, dodecamethylpentasiloxane, tetradecamethylhexasiloxane, hexadeamethylheptasiloxane, heptamethyl-3-{(trimethylsilyl)oxy)}trisiloxane, hexamethyl-3,3, bis{(trimethylsilyl)oxy}trisiloxane pentamethyl{(trimethylsilyl)oxy}cyclotrisiloxane as well as polydimethylsiloxanes, polyethylsiloxanes, polymethylethylsiloxanes, polymethylphenylsiloxanes, polydiphenylsiloxanes, caprylyl methicone, hexamethyldisiloxane, heptamethyloctyltrisiloxane, hexyltrimethicone, and the like, as well as derivatives, modifications, and combinations thereof. Additional examples of suitable silicone fluids include polyorganosiloxanes with suitable vapor pressures, such as from 5×10⁻⁷ to 1.5×10⁻⁶ m²/s.

In certain embodiments, the carrier vehicle comprises an organic fluid, which typically comprises an organic oil including a volatile and/or semi-volatile hydrocarbon, ester, and/or ether. General examples of such organic fluids include volatile hydrocarbon oils, such as C₆-C₁₆ alkanes, C₈-C₁₆ isoalkanes (e.g. isodecane, isododecane, isohexadecane, etc.), C₈-C₁₆ branched esters (e.g. isohexyl neopentanoate, isodecyl neopentanoate, etc.), and the like, as well as derivatives, modifications, and combinations thereof. Additional examples of suitable organic fluids include aromatic hydrocarbons, aliphatic hydrocarbons, alcohols having more than 3 carbon atoms, aldehydes, ketones, amines, esters, ethers, glycols, glycol ethers, alkyl halides, aromatic halides, and combinations thereof. Hydrocarbons include isododecane, isohexadecane, Isopar L (C₁₁-C₁₃), Isopar H (C₁₁-C₁₂), hydrogentated polydecene. Ethers and esters include isodecyl neopentanoate, neopentylglycol heptanoate, glycol distearate, dicaprylyl carbonate, diethylhexyl carbonate, propylene glycol n-butyl ether, ethyl-3 ethoxypropionate, propylene glycol methyl ether acetate, tridecyl neopentanoate, propylene glycol methylether acetate (PGMEA), propylene glycol methyl ether (PGME), octyldodecyl neopentanoate, diisobutyl adipate, diisopropyl adipate, propylene glycol dicaprylate/dicaprate, octyl ether, octyl palmitate, and combinations thereof. It will be appreciated that some examples of the organic fluids above (e.g. glycol ethers) may overlap in description with the polyether alcohol compound (B), which may itself be utilized as a carrier vehicle, or in combination with another carrier vehicle described herein. In some embodiments, the method is carried out free from, alternatively substantially free from, organic fluids meeting the description of the polyether alcohol compound (B) (i.e., other than the polyether alcohol compound (B) itself).

In some embodiments, the carrier vehicle comprises an organic solvent. Examples of organic solvents include those comprising an alcohol, such as methanol, ethanol, isopropanol, butanol, and n-propanol; a ketone, such as acetone, methylethyl ketone, and methyl isobutyl ketone; an aromatic hydrocarbon, such as benzene, toluene, and xylene; an aliphatic hydrocarbon, such as heptane, hexane, and octane; a halogenated hydrocarbon, such as dichloromethane, 1,1,1-trichloroethane, and chloroform; dimethyl sulfoxide; dimethyl formamide, acetonitrile; tetrahydrofuran; white spirits; mineral spirits; naphtha; n-methylpyrrolidone; and the like, as well as derivatives, modifications, and combination thereof.

In certain embodiments, the carrier vehicle comprises a polar organic solvent, such as a solvent compatible with water. Specific examples of such polar organic solvents utilized in certain embodiments include methanol, ethanol, 1-propanol, 2-propanol, 2-methyl-2-propanol, 2-butanone, tetrahydrofuran, acetone, and combinations thereof. Other carrier vehicles may also be utilized in place of, in addition to, or in combination with, those described herein. In certain embodiments, the carrier vehicle comprises, alternatively is, an aliphatic and/or aromatic hydrocarbon solvent such as xylenes, etc., a siloxane solvent such as hexamethylene disiloxane (HMDSO), D4 or D5 cyclics or other such siloxanes, or a combination thereof. In other embodiments, the method is carried out substantially free from certain solvents. For example, in some embodiments, the method is carried out free from, alternatively substantially free from, hexamethylene disiloxane (HMDSO), D4 cyclics, and/or D5 cyclics. In these or other embodiments, the method is carried out free from, alternatively substantially free from benzene, toluene, ethylbenzene, and xylenes (i.e., BTEX solvents). In these or other embodiments, the method is carried out free from, alternatively substantially free from aromatic solvents.

In certain embodiments, the solid silicone resin is combined with the carrier vehicle prior to being combined with the polyether alcohol compound (B) and optionally the aminosilicon compound (C). In other embodiments, however, the polyether alcohol compound (B) is combined with the carrier vehicle prior to being combined with the solid silicone resin (and optionally the aminosilicon compound (C)) or, alternatively, the components are combined at substantially the same time to give the mixture. Parameters associated with conditions under which these components are combined (e.g. temperature, pressure, etc.) may also be controlled. However, the method may be carried out at ambient conditions.

Typically, the solid silicone resin, the polyether alcohol compound (B), optionally the aminosilicon compound (C), and the carrier vehicle are combined together at a temperature less than 45° C. (i.e., cold-processed) to give the mixture. In some embodiments, however, the solid silicone resin, polyether alcohol compound (B), optionally the aminosilicon compound (C), and the carrier vehicle are combined together at a temperature less than 40° C., alternatively less than 35° C., alternatively less than 30° C., alternatively at around ambient temperature.

In some embodiments, the method comprises reacting the solid silicone resin and the polyether alcohol compound (B) to prepare the polysiloxane (A) in the mixture. In these or other embodiments, with the method utilizes the aminosilicon compound (C), the method may further comprise reacting the solid silicone resin or a reaction intermediary formed by reacting the solid silicone resin and the polyether alcohol compound (B) with the aminosilicon compound (C) to prepare the polysiloxane (A). Generally, the aminosilicon compound (C) hydrolyzes and condenses to give a T siloxy unit having amino functionality in the polysiloxane (A). As introduced above, the reaction of the method may be generally defined or otherwise characterized as a condensation reaction, and certain parameters and conditions of the reaction may be selected by those of skill in the art in view of the particular components being utilized. For example, in some such embodiments, the method comprises disposing a catalyst (i.e., a condensation catalyst) into the mixture. Condensation catalysts, such as those based on tin (e.g. Sn octanoate) or bases (e.g. NaOAc, KOH, etc.), are known in the art, and will be selected based on the method components being utilized. In other embodiments, however, the method is carried out in the absence of any tin catalyst, e.g. to provide the composition as a product free from tin, and thereby avoid limitations associated with tin being carried into the final composition.

When implemented in the method, the catalyst may be utilized in any amount, which will be selected by one of skill in the art, e.g. based on the particular catalyst selected, the concentration/amount of active catalytic species thereof, the nature/type of solid silicone resin and/or polyether alcohol compound (B) selected, the reaction parameters employed, the scale of the reaction (e.g. total amounts of the method components utilized, etc.), etc. The molar ratio of the catalyst to the method components may influence the rate and/or amount of condensation to prepare the polysiloxane (A) in the mixture. Thus, the amount of the catalyst as compared to the method components, as well as the molar ratios therebetween, may vary. Typically, these relative amounts and molar ratios are selected to maximize the reaction of the method components while minimizing the loading of the catalyst (e.g. for increased economic efficiency of the reaction, increased ease of purification of the reaction product formed, etc.).

In certain embodiments, the catalyst is utilized in an amount of from 0.000001 to 50 wt. %, based on the total amount of solid silicone resin utilized (i.e., wt./wt.). For example, the catalyst may be used in an amount of from 0.000001 to 25, alternatively from 0.00001 to 10, alternatively from 0.0001 to 5 wt. % based on the total amount of solid silicone resin utilized. In some embodiments, the catalyst is utilized in an amount sufficient to provide a ratio of catalytic tin to hydrolysable groups of the solid silicone resin compound of from 1:10 to 1:1,000,000, alternatively from 1:50 to 1:1,000 alternatively from 1:100 to 1:500. Such ratios may be a weight ratio (i.e., wt./wt.) or, alternatively, a molar ratio between the components. It will be appreciated that amounts and ratios outside of the ranges listed above may be utilized as well. For example, the catalyst may be utilized in a stoichiometric amount (i.e., a supracatalytic amount), e.g. based on the total amount of the polyether alcohol compound (B) utilized in the mixture.

The catalyst may be prepared or otherwise obtained (i.e., as a prepared compound). Methods of preparing condensation catalysts (e.g. tin catalyst, acetate catalyst, etc.) are known in the art, using compounds that are commercially available from various suppliers. The catalyst may thus be prepared prior to the reaction of the solid silicone resin and the polyether alcohol compound (B) (and optionally the aminosilicon compound (C)), or in situ (i.e., during the reaction of those components, e.g. via combining components of the catalyst with the mixture comprising the solid silicone resin and the polyether alcohol compound (B). As such, in certain embodiments, the catalyst is prepared as part of the preparation method, i.e., the preparation method includes preparing the catalyst.

When a condensation reaction is desired, the method will typically further comprise exposing the mixture to one or more condensation conditions, such as elevated temperature, reduced pressure, reflux, etc. As such, the vessel or reactor may be heated or cooled in any suitable manner, e.g. via a jacket, mantle, exchanger, bath, coils, etc., so as to allow for the reaction to be carried out at an elevated or reduced temperature, pressure, etc., as described below. For example, based on the nature of the condensation reaction, the condensation conditions may include heating the mixture to an elevated temperature such as 100° C., e.g. to promote condensation of the polyether alcohol compound (B) and the solid silicone resin (and optionally the aminosilicon compound (C)). Similarly, the condensation conditions may include pulling a vacuum on the reactor being utilized to subject the mixture to reduced pressure (e.g. from 35 to 300 mbar). In combination, the reduced pressure and elevated temperature may be utilized to distill water from the reaction, thereby driving the condensation toward completion by preventing the reverse reaction. One of skill in the art will appreciate that the particular temperature and pressure being utilized will be selected based on the method components and carrier vehicle present in the mixture, e.g. to provide efficient refluxing conditions without over-heating the mixture. For example, in various embodiments, the reaction is carried out at a reaction/condensation temperature of from 23 to 200° C., such as from greater than ambient temperature (e.g. greater than 25° C.) to 200° C., alternatively greater than 25 to 180, alternatively greater than 25 to 165, alternatively greater than 25 to 150, alternatively from 30 to 150, alternatively from 50 to 150, alternatively from 70 to 150, alternatively from 60 to 150, alternatively from 85 to 150, alternatively from 100 to 150, alternatively from 110 to 150° C. In certain embodiments, the reaction temperature is selected and/or controlled based on the boiling point of any one solvent or volatile diluent, such as when utilizing refluxing conditions. Additionally, a cosolvent such as toluene may be utilized to azeotrope water from the mixture.

In general, the reaction speed of the components in the mixture (i.e., the condensation of the polyether alcohol compound (B) and the solid silicone resin, and optionally the aminosilicon compound (C)) increases as i) the reaction temperature increases, and ii) water is removed from the reaction system. As such, the necessary reaction time will be selected in view of the particulars of the mixture being reacted. In exemplary embodiments, the reaction time (i.e., condensation/capping time, which may be monitored via visual inspection, spectroscopy (e.g. NMR, FT-IR, etc.), or other methods known in the art) may be on the order of from 1 to several hours, such as from 1 to 10 hours, alternatively from 2 to 10, alternatively from 3 to 10, alternatively from 4 to 10, alternatively from 4 to 8, alternatively from 4 to 6 hours. However, longer and shorter reaction times my both be selected, e.g. in view of the sixe/scale of the reaction, and any particular components utilized in the mixture.

In certain embodiments, the method comprises dissolving the solid silicone resin in the carrier vehicle (i.e., solvent) to give a silicone resin solution, and combining the silicone resin solution and the polyether alcohol compound (B) to form the mixture. As introduced above, when the method utilizes the aminosilicon compound (C), the aminosilicon compound (C) can be combined with the silicone resin, and/or with the mixture. In these embodiments, e.g. when the carrier vehicle is utilized, the method typically further comprises removing the carrier vehicle from the mixture once the polysiloxane (A) is prepared therein. More specifically, in such embodiments, liquefying the mixture comprises solvent exchanging the solid silicone resin from the solvent/carrier vehicle to the polyether alcohol compound (B), thereby preparing the composition. The solvent exchange is not particularly limited, and may simply involve removing the carrier vehicle from the reactor (e.g. via distillation). For example, in certain embodiments, the method comprises heating the mixture to a temperature of from 60 to 150° C. under reduced pressure (i.e., ˜35 mbar) to remove the solvent and give the composition.

As will be appreciated from the description above and examples herein, the composition prepared via the method provides a liquefied combination of the polysiloxane (A) and the polyether alcohol compound (B), and optionally residual aminosilicon compound (C), if utilized and not fully consumed. The polysiloxane (A) may comprise a condensation reaction product of the solid silicone resin and the polyether alcohol compound (B) (and optionally the aminosilicon compound) or, alternatively, may simply be a liquefied form the of the solid silicone resin (e.g. when no capping/condensation of with the polyether alcohol compound (B) is carried out).

The following examples, illustrating embodiments of this disclosure, are intended to illustrate and not to limit the invention. Unless otherwise noted, all reactions are carried out under air, and all solvents, substrates, and reagents are purchased or otherwise obtained from various commercial suppliers (e.g. Gelest, Acros, Sigma-Aldrich) and utilized as received.

### Equipment and Characterization Parameters

The following equipment and characterization procedures/parameters are used to evaluate various physical properties of the compounds and compositions prepared in the examples below.

### Gel Permeation & Size Exclusion Chromatography (GPC/SEC)

SEC Instrumentation

SEC is performed on a Waters 2695 LC pump and autosampler with a flow rate set at 1 mL/min, and an injection volume set at 100 μL. SEC separation is carried out on 2 Agilent PIgel Mixed-D columns using a Shodex RI-201 differential refractive index detector, each held at 35° C.

Sample Preparation

Samples are prepared in THE eluent to a concentration ˜5 mg/mL polymer/resin. The solution is shaken on a flat-bed shaker at ambient temperature for about 2 hours, and then filtered through a 0.45 um PTFE syringe filter prior to injection.

Processing of Data

Agilent GPC software Cirrus version 3.3 is used for data collection and for data reduction. A total of 16 polystyrene (PS) linear narrow molecular weight standards from Agilent, having Mp values from 3752 to 0.58 kg/mol, are used for molecular weight calibration. A 3^{rd} order polynomial is used for calibration curve fitting, and all molecular weight averages, distributions, and references to molecular weight are provided as PS equivalent values.

FT-IR Analysis

FT-IR instrumentation details are set forth in Table 1 below.

TABLE 1
FT-IR Instrumentation

| Instrument: | Nexus 670 |
|---|---|
| Detector: | DTGS KBr |
| Beam splitter: | Csl |
| Scans: | 64 |
| Collection length: | 77.18 sec |
| Resolution: | 4.000 |

Sample Preparation

Sample Spectrum: Samples are weighed into a 1 cm IR quartz cuvette with a fitted stopper. A specific volume of CCl₄ is added to the cuvette, and the sample mixed thoroughly by shaking. The sample is then measured by IR using the spectral parameters listed below.

Reference Spectrum: Following the sample measurement, approximately 0.5 mL D₂O is added to the cuvette, and the sample mixed vigorously for approximately 30 seconds before being allowed to phase separate. The upper D₂O layer is removed, and the addition/mixing procedure repeated to ensure thorough D₂O exchange. The sample is again allowed to phase separate, and the D₂O left in place. The sample is then again measured by IR (deuterated sample).

Processing of Data

Spectral Subtraction: The deuterated sample spectrum is subtracted from the original sample spectrum to remove invariant features. If the subtraction results showed discernible interference of the water signal at 3610 cm⁻¹ (i.e., little to no —COH present), then a spectrum of water in CCl₄ is subtracted from the original subtraction.

After the subtraction(s), the maximum peak height of the 3690 cm⁻¹ band is measured, and the results used in the following calculation to determine ppm OH of the silanol signal:

$$ppm OH = \frac{Peak height - y intercept}{slope} \times \frac{Sample wt + volume solvent}{Sample wt}$$

### Viscosity Measurement

Brookfield Instrumentation

A Brookfield DV3T cone/plate Rheometer, maintained at 25° C. by water recirculation, is utilized with a CPA-40Z spindle and 0.50 mL material volume for measurement.

Sample Preparation and Procedure

A method based ASTM D 4287 is utilized with a leveled viscometer. For each series of samples, required parameters to the digital viscometer are entered and the position of sample cup adjusted in relation to spindle (cone), as specified by the manufacturer, to maintain required clearance. The sample cup is removed, and 0.5 mL of sample added to the center of the cup using a 1 mL syringe in such a manner that all air bubbles are excluded from the material. The sample is allowed to equilibrate at 25+/−0.1° C. The motor is started at the specified speed, and the digital readout of viscosity noted. Prior to samples, the instrument is calibrated using a Standard 200 Fluid (viscosity close to samples, if possible) as a control.

### ²⁹Si NMR

For ²⁹Si NMR, 2.5 to 3 g of each product prepared below and about 5 g of solvent (CDCl₃+Cr(acac)₃) were loaded into a 16 mm silicon free NMR tube and the spectra were obtained as per conditions and instrumentation in Table 2 below:

TABLE 2
²⁹Si NMR Instrumentation

| Parameter: | ²⁹Si | |
|---|---|---|
| Instrument | Agilent 500 DD2 NMR Spectrometer | |
| NMR Probe | 16 mm Si Free AutoX Probe | |
| Spectrometer Field Strength | 11.7 | T |
| Pulse Sequence | S2PUL | |
| Number scans (nt): | 64 | |
| Acquisition Time (at): | 1.0161 | s |
| Delay Time (d1): | 13 | s |
| Pulse Width (pw) | 18 | μs |
| Solvent | CDCl3 + Cr(acac)3 | |
| Decoupler modulation (dm) | nny | |
| Decoupler offset frequency (dof) | −400 | hz |
| Decoupler modulation field (dmf) | 8812 | hz |
| Decoupler sequence (dseq) | Waltz16 | |
| Transmitter offset frequency (tof) | −5006 | hz |

### Materials

A brief summary is provided in Table 3 below, setting forth information as to certain abbreviations, shorthand notations, and components utilized in the Examples.

TABLE 3
Materials Utilized

| Component | Description |
|---|---|
| Silicone Resin 1 (SR-1) | MQ resin: M/Q ratio~0.94; Mw~3450; solids = 71.5% in |
| | xylene |
| Silicone Resin 2 (SR-2) | MQ resin: M/Q ratio~0.98; Mw~8550; solids = 71.54% |
| | in xylene |
| Silicone Resin 3 (SR-3) | MM^{Vi}Q resin: M/Q ratio~0.76; M^{Vi} content~0.05 |
| | (mole %); Mw~23,500; solids = 72.5% |
| Silicone Resin 4 (SR-4) | MM^{Vi}Q resin: M/Q ratio~0.62; M^{Vi} content~0.11 |
| | (mole %); Mw~25,000; solids = 65.3% |
| Polyether Alcohol 1 (PA-1) | Branched secondary alcohol ethoxylate of trimethyl |
| | nonanol: EO~3; fn = 1 |
| Polyether Alcohol 2 (PA-2) | Branched secondary alcohol ethoxylate of trimethyl |
| | nonanol: EO~5; fn = 1 |
| Polyether Alcohol 3 (PA-3) | Branched secondary alcohol ethoxylate of trimethyl |
| | nonanol: EO~10; fn = 1 |
| Polyether Alcohol 4 (PA-4) | Dipropylene glycol butyl ether: fn = 1; Mw = 363 |
| Polyether Alcohol 5 (PA-5) | EO/PO glycol butyl ether: fn = 1; Mw = 272 |
| Polyether Alcohol 6 (PA-6) | C12-EO/PO glycol ether |
| Polyether Alcohol 7 (PA-7) | Block polyalkoxylate (PO-EO): fn = 3; Mw = 1652 |
| Polyether Alcohol 8 (PA-8) | Random polyalkoxylate (PO-EO): fn = 3; Mw = 1030 |
| Polyether Alcohol 9 (PA-9) | EO/PO glycol butyl ether, fn = 1, Mw = 190 |
| Condensation Catalyst 1 | Sn Octanoate |
| Aminosilicon Compound | 3-aminopropyltriethoxysilane |

### Example 1

246.7 g of Silicone Resin 1 and 79.93 g of Polyether Alcohol 1 were loaded into a 1000 mL 4-neck flask. 0.15 g of Condensation Catalyst 1 was added and the contents adjusted to 50 wt. % solids (SR+PA) by addition of xylene (total weight=506.7 g). The flask was mixed with an overhead stirrer at 200 rpm and then heated to 80° C. for 15 min. A Dean-Stark trap was attached to the flask and the contents refluxed at 140° C. for 4 hours, collecting the water of reaction. The flask was cooled to room temperature and rotovaped under vacuum at 100° C. to remove xylene. The product obtained was clear and had a Brookfield viscosity of 1800 cps. The samples were analyzed by GPC, Si NMR, and FT-IR. The product obtained had a resin content of ˜68%.

### Example 2

226.0 g of Silicone Resin 1 and 93.75 g of Polyether Alcohol 2 were loaded into a 1000 mL 4-neck flask. 0.15 g of Condensation Catalyst 1 was added and the contents adjusted to 50 wt. % solids (SR+PA) by addition of xylene (total weight=506.1 g). The flask was mixed with an overhead stirrer at 200 rpm and then heated to 80° C. for 15 min. A Dean-Stark trap was attached to the flask and the contents refluxed at 140° C. for 4 hours, collecting the water of reaction. The flask was cooled to room temperature and rotovaped under vacuum at 100° C. to remove xylene. The product obtained was clear and had a Brookfield viscosity of 1386 cps. The samples were analyzed by GPC, Si NMR, and FT-IR. The product obtained had a resin content of ˜63%.

### Example 3

760.5 g of Silicone Resin 2 and 223.7 g of Polyether Alcohol 1, were loaded into a 1500 mL 4-neck flask. 0.3 g of Condensation Catalyst 1 was added and the contents adjusted to 75 wt. % solids (SR+PA) by addition of xylene (total weight=1018.5 g). The flask was mixed with an overhead stirrer at 200 rpm and then heated to 80° C. for 15 min. A Dean-Stark trap was attached to the flask and the contents refluxed at 140° C. for 4 hours, collecting the water of reaction. The flask was cooled to room temperature and rotovaped under vacuum at 100° C. to remove xylene. The product obtained was clear and had a Brookfield viscosity of 63,500 cps. The samples were analyzed by GPC, Si NMR, and FT-IR. The product obtained had a resin content of ˜70%.

### Example 4

702.5 g of Silicone Resin 2 and 263.8 g of Polyether Alcohol 2 were loaded into a 1500 mL 4-neck flask. 0.3 g of Condensation Catalyst 1 was added and the contents adjusted to 75 wt. % solids (SR+PA) by addition of xylene (total weight=1017.1 g). The flask was mixed with an overhead stirrer at 200 rpm and then heated to 80° C. for 15 min. A Dean-Stark trap was attached to the flask and the contents refluxed at 140° C. for 4 hours, collecting the water of reaction. The flask was cooled to room temperature and rotovaped under vacuum at 100° C. to remove xylene. The product obtained was clear and had a Brookfield viscosity of 15,600 cps. The samples were analyzed by GPC, Si NMR, and FT-IR. The product obtained had a resin content of ˜65%.

### Example 5

330.5 g of Silicone Resin 1 and 122.2 g of Polyether Alcohol 4 were loaded into a 1000 mL 4-neck flask. 0.15 g of Condensation Catalyst 1 was added and the contents adjusted to 70 wt. % solids (SR+PA) by addition of xylene (total weight=508.9 g). The flask was mixed with an overhead stirrer at 200 rpm and then heated to 80° C. for 15 min. A Dean-Stark trap was attached to the flask and the contents refluxed at 140° C. for 4 hours, collecting the water of reaction. The flask was cooled to room temperature and rotovaped under vacuum at 100° C. to remove xylene. The product obtained was clear and had a Brookfield viscosity of 1762 cps. The samples were analyzed by GPC, Si NMR, and FT-IR. The product obtained had a resin content of ˜65%.

### Example 6

322.7 g of Silicone Resin 1 and 127.3 g of Polyether Alcohol 5 were loaded into a 1000 mL 4-neck flask. 0.15 g of Condensation Catalyst 1 was added and the contents adjusted to 70 wt. % solids (SR+PA) by addition of xylene (total weight=508.8 g). The flask was mixed with an overhead stirrer at 200 rpm and then heated to 80° C. for 15 min. A Dean-Stark trap was attached to the flask and the contents refluxed at 140° C. for 4 hours, collecting the water of reaction. The flask was cooled to room temperature and rotovaped under vacuum at 100° C. to remove xylene. The product obtained was clear and had a Brookfield viscosity of 46,400 cps. The samples were analyzed by GPC, Si NMR, and FT-IR. The product obtained had a resin content of ˜64%.

### Example 7

58.5 g of Silicone Resin 1, 57.4 g of Polyether Alcohol 3, and 25.6 g of Polyether Alcohol 6 were loaded into a 500 mL 4-neck flask. 0.19 g of Condensation Catalyst 1 was added and the contents adjusted to 70 wt. % solids (SR+PA) by addition of xylene (total weight=141.8 g). The flask was mixed with an overhead stirrer at 200 rpm and then heated to 80° C. for 15 min. A Dean-Stark trap was attached to the flask and the contents refluxed at 140° C. for 4 hours, collecting the water of reaction. The flask was cooled to room temperature and rotovaped under vacuum at 100° C. to remove xylene. The product obtained was clear and had a Brookfield viscosity of 185 cps. The samples were analyzed by GPC, Si NMR, and FT-IR. The product obtained had a resin content of ˜41%.

### Example 8

436 g of Silicone Resin 1 and 2574.9 g of Polyether Alcohol 7 were loaded into a 5000 mL 4-neck flask. 0.9 g of Condensation Catalyst 1 was added and the contents adjusted to 45 wt. % solids (SR+PA) by addition of xylene (total weight=3013.5 g). The flask was mixed with an overhead stirrer at 200 rpm and then heated to 80° C. for 15 min. A Dean-Stark trap was attached to the flask and the contents refluxed at 140° C. for 4 hours, collecting the water of reaction. The flask was cooled to room temperature and rotovaped under vacuum at 100° C. to remove xylene. The product obtained was clear to hazy and had a Brookfield viscosity of 185 cps. The samples were analyzed by GPC, Si NMR, and FT-IR. The product obtained had a resin content of ˜10%.

### Example 9

291 g of Silicone Resin 1 and 716.6 g of Polyether Alcohol 7 were loaded into a 2000 mL 4-neck flask. No condensation catalyst was added. The contents were adjusted to 90 wt. % solids (SR+PA) by addition of xylene (total weight=1007.6 g). The flask was mixed with an overhead stirrer at 200 rpm and then heated to 60° C. for 15 min. The flask was cooled to room temperature and rotovaped under vacuum at 100° C. to remove xylene. The product obtained was clear and had a Brookfield viscosity of 185 cps. The samples were analyzed by GPC, Si NMR, and FT-IR. The product obtained had a resin content of ˜20%.

### Example 10

246.8 g of Silicone Resin 1 and 704.1 g of Polyether Alcohol 8 were loaded into a 2000 mL 4-neck flask. No condensation catalyst was added. The contents were adjusted to 90 wt. % solids (SR+PA) by addition of xylene (total weight=950.8 g). The flask was mixed with an overhead stirrer at 200 rpm and then heated to 60° C. for 15 min. The flask was cooled to room temperature and rotovaped under vacuum at 100° C. to remove xylene. The product obtained was clear and had a Brookfield viscosity of 185 cps. The samples were analyzed by GPC, Si NMR, and FT-IR. The product obtained had a resin content of ˜20%.

### GPC and FT-IR Analysis for Examples 1-10

The results of the GPC and FT-IR analysis for the initial MQ resins and the compositions obtained in Examples 1-10 are set forth in Tables 4-6 below.

GPC compositions were obtained by deconvolution of GPC spectra and calibration of free MQ resin (SR) and free alcohol compound (PA).

Based on the amount of free alcohol (PA) calculated, remaining alcohol was assumed to be reacted (capped) on to the MQ resin (SR), and MQ-OR is estimated assuming molar capping onto the MQ resin. For the FTIR results, assuming Si—OH reduction is from capping of the alcohol, MQ-OR are overestimated compared to GPC. Based on this assumption, SiOH ppm from spectra are normalized to the initial MQ resin SiOH signal in each case, to estimate the reduction of SiOH signal to reaction with the alcohol compound.

TABLE 4
GPC Data for Initial MQ Resins of Examples 1-10

| | SR | PA | Vis- | | | | | |
|---|---|---|---|---|---|---|---|---|
| Ex- | Wt. % | Wt. % | cosity | GPC of MQ Resin (SR) | | | | |
| ample | (est.) | (est.) | (cps) | Mn | Mw | Mz | Mp | PD |
| 1 | 68 | 32 | 1800 | 2420 | 3370 | 5280 | 9180 | 1.39 |
| 2 | 63 | 37 | 1386 | 3390 | 4520 | 6120 | 8170 | 1.33 |
| 3 | 70 | 30 | 63500 | 3880 | 8470 | 19000 | 3150 | 2.18 |
| 4 | 65 | 35 | 15600 | 4550 | 7270 | 11900 | 6770 | 1.6 |
| 5 | 65 | 35 | 1762 | 2607 | 3360 | 4675 | 6507 | 1.29 |
| 6 | 64 | 36 | 46400 | 2809 | 3750 | 5214 | 7166 | 1.33 |
| 7 | 32.8 | 67.2 | 185 | Not Analyzed | | | | |
| 8 | 10 | 90 | 18450 | 4800 | 7930 | 11100 | 17880 | 1.65 |
| 9 | 20 | 80 | 505 | 4930 | 6830 | 7810 | 8610 | 1.39 |
| 10 | 20 | 80 | 363 | 3830 | 4380 | 4740 | 5030 | 1.14 |

TABLE 5
GPC Data for Compositions of Examples 1-10

| | SR | PA | | Final Composition (GPC) | | |
|---|---|---|---|---|---|---|
| | Wt. % | Wt. % | Viscosity | Free PA | Free SR | MQ-OR |
| Example | (est.) | (est.) | (cps) | (%) | (%) | (%) |
| 1 | 68 | 32 | 1800 | 26.0 | 57.8 | 16.2 |
| 2 | 63 | 37 | 1386 | 26.0 | 48.3 | 25.7 |
| 3 | 70 | 30 | 63500 | 28.0 | 66.6 | 5.4 |
| 4 | 65 | 35 | 15600 | 22.0 | 47.7 | 30.3 |
| 5 | 65 | 35 | 1762 | 34.0 | 63.5 | 2.5 |
| 6 | 64 | 36 | 46400 | 27.2 | 50.9 | 21.9 |

| | | | | |
|---|---|---|---|---|
| 7 | 32.8 | 67.2 | 185 | Not Analyzed |
| 8 | 10 | 90 | 18450 | Overlap of MQ Resin/ |
| 9 | 20 | 80 | 505 | Alcohol Spectra |
| 10 | 20 | 80 | 363 | |

TABLE 6
FT-IR Data for Compositions of Examples 1-10

| | | | | Final Composition (FT-IR) | | | |
|---|---|---|---|---|---|---|---|
| | SR Wt. % | PA Wt. % | Viscosity | OH | Free PA | Free SR | MQ-OR |
| Example | (est.) | (est.) | (cps) | (ppm) | (%) | (%) | (%) |
| 1 | 68 | 32 | 1800 | 5027.0 | 21.0 | 40.0 | 39.0 |
| 2 | 63 | 37 | 1386 | 1640.0 | 14.4 | 13.0 | 72.5 |
| 3 | 70 | 30 | 63500 | 3611.0 | 28.8 | 66.8 | 4.4 |
| 4 | 65 | 35 | 15600 | 444.0 | 10.2 | 7.1 | 82.7 |
| 5 | 65 | 35 | 1762 | 5673.0 | 26.6 | 45.1 | 28.3 |
| 6 | 64 | 36 | 46400 | 3419.0 | 22.9 | 27.2 | 49.9 |
| 7 | 32.8 | 67.2 | 185 | 2239.0 | 34.8 | 12.7 | 31.7 |
| 8 | 10 | 90 | 18450 | 888.0 | 87.7 | 7.1 | 5.2 |
| 9 | 20 | 80 | 505 | 1807.0 | 75.7 | 14.4 | 10.0 |
| 10 | 20 | 80 | 363 | 2265.0 | 78.7 | 18.0 | 3.3 |

Referring to the Tables 4-6 above, all compositions have >10 to 70 wt. % of MO resin (SR), either solubilized or partially grafted (capped) with alcohol/capping agents (PA) to give liquid silicone resin compositions.

### Examples 11-13

Three compositions are prepared according to the procedures of Examples 1-10 above, using Silicone Resin 2 and various alcohols/capping agents (PA) to prepare Examples 11-13, the details of which are set forth in Table 7 below, along with the Brookfield viscosity of the resulting compositions.

TABLE 7
Components and Viscosities of Examples 11-13

| | | | Cap | SR Wt. % | PA Wt. % | Viscosity |
|---|---|---|---|---|---|---|
| Example | M/Q Ratio | PA | Ratio | (est.) | (est.) | (cps) |
| 11 | 0.8 | PA-1 | 1 | 62 | 38 | 8400 |
| 12 | 0.8 | PA-2 | 1 | 56 | 44 | 2240 |
| 13 | 1 | PA-3 | 1 | 44 | 56 | 18,750 |

The compositions were analyzed for % of capping via ²⁹Si NMR, the results of which are shown in Table 8 below, where “I” designates an initial sample, and “F” designates the final compositions prepared. In Table 8, M indicates an M siloxy unit; D indicates a D siloxy unit; T indicates a T siloxy unit; Q indicates a Q siloxy unit; and Z is independently H or alkyl. OZ indicates an SiOZ group in lieu of a siloxane bond.

TABLE 8
²⁹Si NMR Analysis for Examples 11-13

| | | | | | | M/Q | Mol % |
|---|---|---|---|---|---|---|---|
| Example | M | D(OZ, OZ) | T(OZ) | Q | T(OH) | Ratio | Cap |
| 11-I | 33.7 | 0.4 | 14.8 | 41.4 | 14.8 | 0.8 | — |
| 11-F | 37.8 | −0.1 | 17.5 | 38.7 | 17.5 | 1.0 | 0 |
| 12-I | 40 | −0.2 | 8.9 | 47.3 | 8.9 | 0.8 | — |
| 12-F | 44.9 | 0.1 | 11.9 | 44.3 | 3.8 | 1.0 | 68.3 |
| 13-I | 42.1 | 0.6 | 13.2 | 43 | 13.2 | 1.0 | — |
| 13-F | 47 | 0 | 13.5 | 42.7 | 5.5 | 1.1 | 58.9 |

The compositions of Examples 11-13 were also analyzed via GPC against polystyrene standards, the results of which are shown in Table 9 below, where “I” designates an initial sample, and “F” designates the final compositions prepared.

TABLE 9
GPC Analysis for Examples 11-13

| Example | Peak RT (min) | Mn | Mw | Mz | Mp | PD |
|---|---|---|---|---|---|---|
| 11-I | 13.7-17.8 | 3840 | 8430 | 18500 | 3090 | 2.19 |
| 11-F | 13.6-17.8 | 3890 | 8550 | 19000 | 7080 | 2.2 |
| 12-I | 14.1-17.5 | 3730 | 6520 | 11900 | 3130 | 1.75 |
| 12-F | 14.3-17.5 | 4430 | 6720 | 10200 | 6520 | 1.52 |
| 13-I | 14.6-17.0 | 4680 | 6230 | 8830 | 2970 | 1.33 |
| 13-F | 14.2-17.1 | 6190 | 9170 | 13600 | 8500 | 1.48 |

### Examples 14-18

Five compositions were prepared according to the procedures of Examples 1-10 above, using various MQ resins (SR) and capping agents (PA) to prepare Examples 14-18, the details of which are set forth in Table 10 below, along with the viscosity of the resulting compositions.

TABLE 10
Components and Viscosities of Examples 14-18

| | | | | SR Wt. % | PA Wt. % | Viscosity |
|---|---|---|---|---|---|---|
| Example | SR | PA | Cap Ratio | (est.) | (est.) | (cps) |
| 14 | SR-3 | PA-1 | 0.95 | 0.77 | 0.23 | >700,000 |
| 15 | SR-3 | PA-2 | 0.95 | 0.72 | 0.28 | 695,300 |
| 16 | SR-4 | PA-1 | 0.95 | 0.79 | 0.21 | >700,000 |
| 17 | SR-4 | PA-2 | 0.95 | 0.74 | 0.26 | 180,400 |
| 18 | SR-1 | PA-1 | 1 | 0.6 | 0.4 | 1060 |

### Example 19

291.7 g of Silicone Resin 2 and 140 g of Polyether Alcohol 9 were loaded into a 2000 mL 4-neck flask. No condensation catalyst was added. The flask was rotovaped under a vacuum of 2-5 mm Hg at 60° C. to remove 81.68 g of xylene. The product obtained was clear and had a Brookfield viscosity of 1230 cps. The samples were analyzed by GPC, Si NMR, and FT-IR. The product obtained had a resin content of ˜60%.

### Example 20

100 g of the product formed in Example 19 and 6 g Aminosilicon Compound were cold blended for 3 hours at 60 revolutions per minute (rpm) at room temperature for a loading of 10% Aminosilicon Compound based on the resin content of the product formed in Example 19.

### Example 21

100 g of the product formed in Example 19 and 6 g Aminosilicon Compound were blended for 3 hours at 60 rpm and heated at 80° C. in a rotovap at a vacuum of 300 mm Hg.

### Example 22

100 g of the product formed in Example 19 and 12 g Aminosilicon Compound were blended for 3 hours at 60 rpm and heated at 80° C. in a rotovap at a vacuum of 300 mm Hg.

The results of the GPC and FT-IR analysis for the products compositions obtained in Examples 19-22 are set forth in Table 11 below.

TABLE 11
Mw and PD of Examples 19-22

| Example | Mw | PD |
|---|---|---|
| 19 | 8219 | 2.25 |
| 20 | 4865 | 1.799 |
| 21 | 5530 | 1.882 |
| 22 | 4197 | 1.6923 |

The products of Examples 19-22 were analyzed for siloxy unit content via ²⁹Si NMR, the results of which are shown in Table 12 below. In Table 12, Z is H or alkyl; Me is methyl; NeoPentyl is (CH₃)₃CCH₂; A.S.C. indicates Aminosilicon Compound; X is independently H, a hydrocarbyl group R having from 1 to 30 carbon atoms, or a polyether moiety formed by the Polyether Alcohol 9; and T′ indicates an H₂NCH₂CH₂CH₂SiO_{3/2} siloxy unit. The values in Table 12 are mole fractions.

TABLE 12
Siloxy unit content of Examples 19-22

| Unit | 19 | 20 | 21 | 22 | A.S.C. |
|---|---|---|---|---|---|
| Me₃SiOZ | 0 | 0.11 | 0 | 0.25 | 0 |
| Me₃SiO_{1/2} | 42.15 | 40.47 | 40.36 | 39.74 | 0 |
| NeoPentylMe₂SiO_{1/2} | 1.51 | 1.88 | 1.75 | 1.62 | 0 |
| R′Si(OZ)₃ | 0 | 0.25 | 0 | 0.75 | 97.07 |
| CH₃(OZ)₂SiO_{1/2} | 0 | 0.82 | 0.59 | 1.46 | 2.93 |
| CH₃(OZ)SiO_{2/2} | 0 | 1.49 | 1.51 | 1.7 | 0 |
| T′ | 0 | 1.72 | 2.96 | 3 | 0 |
| (OX)SiO_{3/2} | 13.41 | 7.56 | 8.05 | 5.84 | 0 |
| SiO_{4/2} | 42.93 | 45.69 | 44.79 | 45.65 | 0 |

The invention has been described in an illustrative manner, and it is to be understood that the terminology which has been used is intended to be in the nature of words of description rather than of limitation. Obviously, many modifications and variations of the present invention are possible in light of the above teachings. The invention may be practiced otherwise than as specifically described.

1. A liquid silicone resin composition, said composition comprising:
(A) a polysiloxane having the following formula:
(R¹₃SiO_{1/2})ₐ(R²₂SiO_{2/2})_{b}(R′R²SiO_{2/2})_{b′}(R²SiO_{3/2})_{c}(R′SiO_{3/2})_{c′}(SiO_{4/2})_{d},
wherein subscripts a, b, b′, c, c′, and d are each mole fractions such that a+b+b′+c+c′+d=1, with the provisos that 0<a<1, 0≤b<0.2, 0≤b′≤0.1, 0<c<0.2, 0≤c′≤0.1, 0<d<1, and 0≤b′+c′≤0.1, and the ratio of subscript a to subscript d is from 0.5 to 1.5 (a:d); each R¹ is independently selected from hydrocarbyl groups having from 1 to 30 carbon atoms, —OH, and H; each R² is independently selected from R¹ and —OX, where each X is independently H, a hydrocarbyl group R having from 1 to 30 carbon atoms, or a polyether moiety having the general formula —Y—R³(—[Y]ⱼ—Z)ᵢ, wherein R³ is a substituted or unsubstituted hydrocarbon segment, each Y is an independently selected oxyalkylene segment of general formula (CₙH₂ₙO)ₘ, where subscript m is from 1 to 50 and subscript n is independently selected from 2 to 4 in each moiety indicated by subscript m, each Z is independently H or a resinous silicone moiety, subscript i is from 0 to 8, and subscript j is independently 0 or 1 in each moiety indicated by subscript i; and each R′ comprises an independently selected amino group; and
(B) a polyether alcohol compound having the general formula HO—Y—R³(—[Y]ⱼ—H)ᵢ, wherein each Y, R³, subscript i, and subscript j are as defined above.

2. The liquid silicone resin composition of claim 1, wherein: (i) the ratio of M siloxy units indicated by subscript a to Q siloxy units indicated by subscript d is from 0.7 to 1.2 a:d; (ii) subscript a is from 0.3 to 0.6; (iii) the sum of subscripts b and c is less than 0.2; (iv) subscript d is from 0.4 to 0.7; (v) the polysiloxane (A) comprises a weight-average molecular weight (Mw) of from 2000 to 30,000; or (vi) any combination of (i)-(v).

3. The liquid silicone resin composition of claim 1, wherein in the polysiloxane (A): (i) each R² is independently of formula —OX in the T siloxy units indicated by subscript c; (ii) X is the polyether moiety in from 1 to 90 mole % of each R² of formula —OX; (iii) each R¹ is independently selected from alkyl and aryl groups containing 1-30 carbon atoms and H; or (iv) any combination of (i)-(iii).

4. The liquid silicone resin composition of claim 1, wherein in the polysiloxane (A): (i) each R² is independently selected from R¹ and hydrocarbyloxy groups of formula —OR; (ii) each R¹ is independently selected from alkyl and aryl groups containing 1 to 30 carbon atoms, —OH, and H; (iii) each R is independently selected from alkyl and aryl groups containing 1 to 30 carbon atoms; (iv) each R′ is independently of formula —(CH₂)_{g}N(H)_{f}R_{2-f}, where each g is independently from 1 to 30, f is 0, 1, or 2, and R is independently selected and defined above; or (v) any combination of (i)-(iv).

5. The liquid silicone resin composition of claim 1, wherein the hydrocarbon segment R³ comprises: (i) a linear or branched hydrocarbon group having from 3 to 30 carbon atoms; (ii) an aromatic group; (iii) an ether group; (iv) an amine group; or (v) any combination of (i)-(iv).

6. The liquid silicone resin composition of claim 1, wherein: (i) the hydrocarbon segment R³ comprises a branched hydrocarbon group having from 3 to 16 carbon atoms; (ii) subscript i is from 1 to 8; (iii) subscript j is 1 in each moiety indicated by subscript i; (iv) each oxyalkylene segment Y independently has the formula (C₂H₄O)ₓ(C₃H₆O)_{y}(C₄H₈O)_{z}, where subscript x is from 1 to 50, subscript y is from 0 to 50, and subscript z is from 0 to 50, and where units indicated by subscripts x, y and z may be in randomized or block form in the oxyalkylene segment; or (v) any combination of (i)-(iv).

7. The liquid silicone resin composition of claim 1, wherein: (i) each subscript i is 0, and each hydrocarbon segment R³ independently comprises a linear or branched hydrocarbon group having from 3 to 30 carbon atoms; (ii) each subscript i is 1, and each hydrocarbon segment R³ independently comprises at least one group selected from linear or branched hydrocarbon groups having from 3 to 30 carbon atoms, phenols, tetrahydrofurans, alkyl amines, and alkoxy groups; or (iii) each subscript i is at least 2, and each hydrocarbon segment R³ independently comprises at least one group selected from linear or branched hydrocarbon groups having from 3 to 30 carbon atoms, alkyl amines, polyamines, polyamides, polyaziridines, polyphenols, and polyesters.

8. The liquid silicone resin composition of claim 1, wherein the polyether alcohol compound (B) comprises the alkoxylation reaction product of (b-1) an organic compound comprising an alkoxylatable group having an O-, N-, or S-bonded hydrogen atom and (b-2) an alkylene oxide or polyoxyalkylene compound.

9. The liquid silicone resin composition of claim 8, wherein: (i) the organic compound (b-1) is further defined as an alcohol compound comprising from 1 to 9 hydroxyl groups; (ii) the alkylene oxide or polyoxyalkylene compound (b-2) is selected from ethylene oxide, propylene oxide, butylene oxide, a combination thereof, or a polyoxyalkylene formed therefrom; or (iii) both (i) and (ii).

10. The liquid silicone resin composition of claim 8, wherein the polyether alcohol compound (B) comprises: (i) a polydispersity index (PDI) less than 1.15; (ii) a molecular weight (Mw) of less than 5000; (iii) less than 2 wt. % unreacted alcohol compound (b-1), based on the total weight of the polyether alcohol compound (B); or (iv) any combination of (i)-(iii).

11. The liquid silicone resin composition of claim 1, comprising: (i) from 10 to 80 wt. % of the polysiloxane (A), based on the total weight of the composition; (ii) from 10 to 95 wt. % of the polyether alcohol compound (B), based on the total weight of the composition; (iii) a viscosity at 25° C. of from 100 to 800,000 cps; or (iv) any combination of (i)-(iii).

12. The liquid silicone resin composition of claim 1, wherein the composition: (i) is free from tin; (ii) is free from cyclic siloxanes; (iii) comprises less than 1 wt. % of solvent, based on the total weight of the composition; or (iv) any combination of (i)-(iii).

13. A method of preparing the liquid silicone resin composition of claim 1, said method comprising:
combining together a solid silicone resin and the polyether alcohol compound (B) to give a mixture comprising the polysiloxane (A) and the polyether alcohol compound (B), wherein the solid silicone resin has the following formula:
(R¹₃SiO_{1/2})ₐ(R⁴₂SiO_{2/2})_{b}(R⁴SiO_{3/2})_{c}(SiO_{4/2})_{d},
where each R⁴ is independently selected from R¹ and —OR, with the proviso that R⁴ is selected from —OH and —OR in at least one T siloxy unit indicated by subscript c, and each R¹, R, and subscripts a, b, c, and d are as defined above; and
liquefying the mixture, thereby preparing the liquid silicone resin composition.

14. The method of claim 13, further comprising reacting the solid silicone resin and the polyether alcohol compound (B) via condensation to prepare the polysiloxane (A) in the mixture.

15. The method of claim 13, wherein method further comprises combining (C) an aminosilicon compound with the solid silicone resin and the polyether alcohol compound (B), and/or wherein the method further comprises combining (C) an aminosilicon compound with the mixture before and/or after liquefying the mixture.

16. The method of claim 15, wherein the aminosilicon compound (C) has the formula R′R¹⁰ₕSi(OR¹⁰)₃₋ₕ, where R′ comprises an amino group, each R¹⁰ is an independently selected alkyl group having from 1 to 18 carbon atoms, and subscript h is 0 or 1.

17. The method of claim 13, wherein the solid silicone resin and the polyether alcohol compound (B) are combined together in the presence of a solvent; wherein the method further comprises dissolving the solid silicone resin in the solvent to give a silicone resin solution; and wherein combining the solid silicone resin and the polyether alcohol compound (B) to form the mixture is further defined as combining the silicone resin solution and the polyether alcohol compound (B).

18. The method of claim 17, wherein liquefying the mixture comprises solvent exchanging the solid silicone resin from the solvent to the polyether alcohol compound (B), and wherein the solvent exchanging is carried out: (i) at a temperature of from 60 to 150° C.; (ii) under reduced pressure; (iii) under distillation conditions to remove solvent; or (iv) any combination of (i)-(iii).

19. The method of claim 17, wherein the solvent comprises: (i) xylenes; (ii) hexamethylene disiloxane; (iii) octamethylcyclotetrasiloxane (D4); (iv) decamethylcyclopentasiloxane (D5); or (v) any combination of (i)-(iv).

20. The method of claim 13, wherein the liquid silicone resin composition: (i) is free from tin; (ii) is free from cyclic siloxanes; (iii) comprises less than 1 wt. % of solvent, based on the total weight of the composition; or (iv) any combination of (i)-(iii).
